(19) United States
(12) Patent Application Publication
(10) Pub. No.: US 2019/0341016 A1
(43) Pub. Date: Nov. 7, 2019

(54) SOUNDPROOF MEMBER

(71) Applicant: FUJIFILM Corporation, Tokyo (JP)

(72) Inventors: Shinya HAKUTA, Ashigara-kami-gun (JP); Shogo YAMAZOE, Ashigara-kami-gun (JP); Akihiko OHTSU, Ashigara-kami-gun (JP)

(73) Assignee: FUJIFILM Corporation, Tokyo (JP)

(21) Appl. No.: 16/514,145

(22) Filed: Jul. 17, 2019

Related U.S. Application Data
(63) Continuation of application No. PCT/JP2018/002928, filed on Jan. 30, 2018.

(30) Foreign Application Priority Data
Feb. 10, 2017 (JP) 2017-023140

(51) Int. Cl. G10K 11/172; E04B 1/84

(52) U.S. Cl. CPC G10K 11/172; E04B 2001/848; E04B 2001/8438; E04B 1/84

(57) ABSTRACT

A soundproof member includes one or more soundproof cells each including a frame having a hole portion and a film fixed to the frame. The film vibrates in response to sound, and the film includes one or more cut portions penetrating from one surface to the other surface. As a result, in the soundproof member, a specific frequency has an absorption peak of noise in order to suppress noise of the specific frequency, and a peak spreads,

### CROSS-REFERENCE TO RELATED APPLICATIONS

This application is a Continuation of PCT International Application No. PCT/JP2018/002928 filed on Jan. 30, 2018, which claims priority under 35 U.S.C. § 119(a) to Japanese Patent Application. No. 2017-023140 tiled on Feb. 10, 2017. The above application is hereby expressly incorporated by reference, in its entirety, into the present application.

### BACKGROUND OF THE INVENTION

### 1. Field of the Invention

The present invention relates to a soundproof member comprising a frame and a film fixed to the frame. Specifically, the present invention relates to a soundproof member in which one or a plurality of soundproof cells each having a cut portion formed by a slit in a film is two-dimensionally arranged and sound having a wide frequency including a target frequency is selectively and intensively shielded.

### 2. Description of the Related. Art

Since the heavier the mass of a general sound insulation material, the better the sound is shielded, the sound insulation material itself becomes large and heavy in order to obtain a favorable sound insulation effect. Meanwhile, it is difficult to shield sound having a low-frequency component in particular. In general, in a case where this region is called the mass law and the frequency has doubled, it has been known that the shielding is increased by 6 dB.

As stated above, since most soundproof members of the related art have performed sound insulation with the mass of the structure, there is a disadvantage that the soundproof structure becomes large and heavy and it is difficult to perform low-frequency shielding.

In contrast, the soundproof member with improved stiffness is reported by attaching a frame to a sheet or a film (see JP4832245B and JP2009-139556A). Such a sound insulation structure can be light and can obtain high shielding performance in a specific frequency compared to the sound insulation member of the related art. It is possible to control a sound insulation frequency by changing the shape of the frame and the stiffness of the film.

JP4832245B discloses a sound absorbing body which includes a frame body having a through opening formed therein and a sound absorbing material covering one opening of the through opening and of which a storage modulus of elasticity of the sound absorbing material is in a specific range.

The sound absorbing body disclosed in JP4832245B can achieve an advanced sound absorption effect in the low-frequency region without increasing the size thereof.

JP2009-139556A discloses a sound absorbing body which is covered with a film material (film-shaped sound absorbing material) that covers an opening part formed in a front part of a cavity which is partitioned by a partition wall as a frame and is closed by a posterior wall (stiff wall) using a plate-shaped member. A pressing plate is placed on the film material. A resonance hole for Helmholtz resonance is formed in the film-shaped sound absorbing material. A resonance hole for a Helmholtz resonance is formed in a region (corner portion) within a range of 20% of a dimension of a surface of the film-shaped sound absorbing material from a fixed end of a peripheral portion of the opening part which is a region in which displacement due to sound waves of the film material is least likely to be caused. In the sound absorbing body, the cavity is blocked except for the resonance hole. This sound absorbing body performs a sound absorbing action by film vibration and a sound absorbing action by a Helmholtz resonance.

### SUMMARY OF THE INVENTION

The film type sound absorbing materials disclosed in JP4832245B and JP2009-139556A are resonant type sound absorbing bodies in which sound absorption characteristics are determined by the film and a rear space or the film, and the resonance hole, and the rear space. Such a sound absorbing body has a feature that absorbance is high in a sound absorption peak but a peak width is narrow. Thus, such a sound absorbing body can be used for controlling noise having a specific frequency through resonance vibration of a machine in general. Hereinafter, “resonance” is generally described except for a case where JP2009-139556A is directly cited.

However, there are the following problems that the machine will not avoid an individual difference or aging.

1. Since a resonance frequency is changed by slight stiffness due to the individual difference and/or a shift in weight, an individual difference in resonance frequency of the machine is large, and thus, it is difficult to cope with a plurality of machines with a narrow peak width.

2. The resonance frequency is gradually changed with aging by using a case where noise is caused by a movable part such as a fan or a pump.

Particularly, in the film type sound absorbing material disclosed in JP2009-139556A, the hole is formed in the film in order to cause both the film vibration and the Helmholtz resonance. In this case, a plurality of peaks is generated in order to cause two resonance states.

As can be apparent that from the object of the technology of JP2009-139556A that “a resonance hole for the Helmholtz resonance formed in a film-shaped sound absorbing material is difficult to inhibit the film vibration of the film-shaped sound absorbing material”, the resonance hole is formed in the end portion in order not to change the original film vibration. That is, in JP2009-139556A, since the absorption through the film vibration resonance itself is not changed as much as possible, the film vibration resonance is the absorption peak in which the frequency width is narrow, the problem about the aging or the individual difference of the machine is not able to be solved.

As stated above, the sound absorbing body having resonance is used in many scenes in which the sound having the specific frequency is intensively transmitted, specifically, in a scene in which sound such as rotation sound of a motor and a vibration resonance sound of the machine is insulated. However, the resonance frequency of the sound is slightly changed depending on the state of the machine.

In this situation, in a case where the resonance peaks are separated even though a plurality of resonance peaks is present as in the sound absorbing material of JP2009-139556A, since the peak widths are not changed one by one, the problem about the change of the resonance frequency due to the state of the machine is not solved. In a case where resonance peak frequencies caused by a plurality of resonances match each other, it is difficult to widen a band of a target resonance peak because the resonances cause interference with each other. Thus, even though such the related arts are used, it is difficult to widen the frequency width of one resonance peak, and there is a problem that it is difficult to cope with the sound having the specific frequency.

An object of the present invention has been made in order to solve the problems of the related art, and is to provide a soundproof member capable of causing a peak to spread in addition to having an absorption peak of noise in a specific frequency in order to suppress noise having the specific frequency.

In order to achieve the object, a soundproof member according to a first aspect of the present invention is a soundproof member comprising one or more soundproof cells. The soundproof cell includes a frame having a hole portion, and a film fixed to the frame, the film vibrates in response to sound, and the film includes one or more cut portions penetrating from one surface to the other surface.

In order to achieve the aforementioned object, at the time of manufacturing the soundproof member according to the first aspect, a method of manufacturing a soundproof member according to a second aspect of the present invention includes preparing one or more frames each having a hole portion, and one or more films respectively fixed to the one or more frames, fixing the one or more films to the one or more frames, respectively, and forming slits on the one or more films respectively fixed to the one or more frames.

In this example, it is preferable that the soundproof cell exhibits resonance that includes vibration of the film, and is different from Helmholtz resonance.

It is preferable that the cut portion is a slit formed by a cutter.

It is preferable that the cut portion is formed along an inner periphery of the frame, and in a case where a perpendicular line is dropped toward a center of gravity of the film vibrating from the inner periphery of the frame, the cut portion is within a range of 50% or less of a length of the perpendicular line from the inner periphery of the frame.

It is preferable that a length of the cut portion is 25% or more of a length of an inner periphery of the frame.

It is preferable that a frame-side cut surface of the film and a center-side cut surface of the film cut by the cut portion have an overlapped portion at least in a part in addition to both ends of the cut portion in a thickness direction of the film.

It is preferable that the frame-side cut surface and the center-side cut surface of the film are in contact with each other at least in a part in addition to both the ends of the cut portion.

It is preferable that the number of cut portions is one.

It is preferable that a rear space of the film surrounded by an inner peripheral surface of the frame is closed.

It is preferable that the one or more soundproof cells are a plurality of the soundproof cells, the soundproof member further includes a different kind of a plurality of other soundproof cells from the soundproof cells, and the other soundproof cell fixes a film obtained by excluding the cut portion from the film to the frame.

It is preferable that the soundproof member further comprises a rear member that closes the rear space of the film.

It is preferable that the film covers one opened end of the hole portion of the frame, and the rear member covers the other opened end of the hole portion of the frame.

According to the present invention, it is possible to cause a peak to spread in addition to having an absorption peak of noise in a specific frequency in order to suppress noise having the specific frequency.

### BRIEF DESCRIPTION OF THE DRAWINGS

FIG. 1 is a schematic perspective view of an example of a soundproof member according to an embodiment of the present invention.

FIG. 2 is a schematic cross-sectional view of the soundproof member shown in FIG. 1 taken along the line II-II.

FIG. 3 is a schematic cross-sectional view of a cut portion of the soundproof member shown in FIG. 1 taken along the line III-III.

FIG. 4 is a schematic top view of the soundproof member shown in FIG. 1.

FIG. 5A is a schematic explanatory diagram for describing an example of a state of cut surfaces of two cut pieces of the cut portion of a film of the soundproof member according to the embodiment of the present invention.

FIG. 5B is a schematic explanatory diagram for describing another example of the state of the cut surfaces of the two cut pieces of the cut portion of the film of the soundproof member according to the embodiment of the present invention.

FIG. 6 is a schematic cross-sectional view of another example of a soundproof member according to another embodiment of the present invention.

FIG. 7 is a schematic top view of another example of a soundproof member according to the embodiment of the present invention.

FIG. 8 is a schematic top view of another example of the soundproof member according to the embodiment of the present invention.

FIG. 9 is a schematic top view of another example of the soundproof member according to the embodiment of the present invention.

FIG. 10 is a schematic top view of another example of the soundproof member according to the embodiment of the present invention.

FIG. 11 is a schematic top view of another example of the soundproof member according to the embodiment of the present invention.

FIG. 12 is a schematic top view of another example of the soundproof member according to the embodiment of the present invention.

FIG. 13 is a graph showing sound absorption characteristics of Example 1 of the present invention which is an example of the soundproof member shown in FIG. 4.

FIG. 14 is a graph showing sound absorption characteristics of Example 2 of the present invention which is an example of the soundproof member shown in FIG. 7.

FIG. 15 is a graph showing sound absorption characteristics of Example 3 of the present invention which is an example of the soundproof member shown in FIG. 8.

FIG. 16 is a graph showing sound absorption characteristics on a low frequency side of soundproof members of Examples 1 and 2 of the present invention and Comparative Example 1.

FIG. 17 is a graph showing sound absorption characteristics of soundproof members of Examples 4 and 5 of the present invention and Comparative Example 2.

FIG. 18 is a graph showing sound absorption characteristics of soundproof members of Examples 6 to 9 of the present invention and Comparative Example 3.

FIG. 19 is a graph showing sound absorption characteristics of soundproof members of Example 10 of the present invention and Comparative Example 3.

FIG. 20 is a graph showing sound absorption characteristics of soundproof members of Examples 11 to 14 of the present invention and Comparative Example 7.

FIG. 21 is a graph showing sound absorption characteristics of a soundproof member of Example 14 of the present invention.

FIG. 22 is a schematic top view of a soundproof member having no cut portion in a film disclosed in JP4832245B.

FIG. 23 is a graph showing sound absorption characteristics of the soundproof member of Comparative Example 1 shown in FIG. 22.

FIG. 24 is a graph showing sound absorption characteristics of the soundproof members of Comparative Examples 4 to 6.

FIG. 25 is a schematic top view of a soundproof member having a Helmholtz resonance hole disclosed in JP2009-139556A.

FIG. 26 is a graph showing sound absorption characteristics of the soundproof member of Comparative Example 7 and the soundproof member of Comparative Example 8 shown in FIG. 25.

FIG. 27 is a graph showing sound absorption characteristics of soundproof members of Example 15 of the present invention and Comparative Example 9.

### DESCRIPTION OF THE PREFERRED EMBODIMENTS

Hereinafter, a soundproof member according to embodiments of the present invention will be described in detail with reference to preferred embodiments shown in the accompanying diagrams.

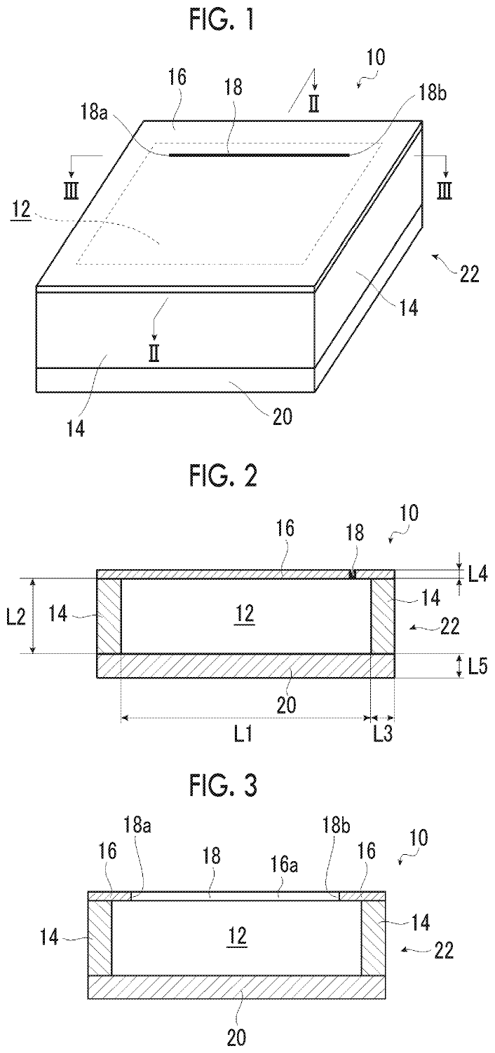

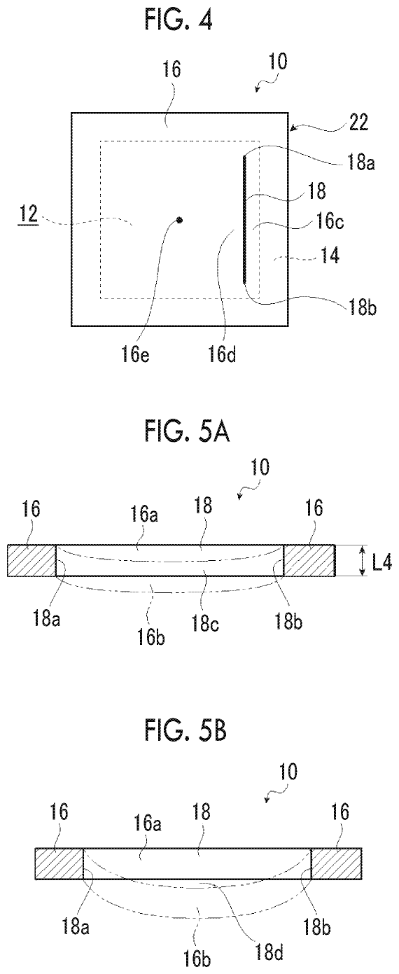

FIG. 1 is a schematic perspective view of an example of the soundproof member according to the embodiment of the present invention. FIG. 2 is a schematic cross-sectional view of the soundproof member shown in FIG. 1 taken along the line FIG. 3 is a schematic cross-sectional view of a cut portion of the soundproof member shown in FIG. 1 taken along the line FIG. 4 is a schematic top view of the soundproof member shown in FIG. 1.

A soundproof member 10 according to the present embodiment shown in FIGS. 1 to 4 is constituted by one soundproof cell 22 that includes a frame 14 having a hole portion 12 penetrating therethrough, a vibratable film 16 fixed to the frame 14 so as to cover one opened surface of the hole portion 12, a cut portion 18 formed in the film 16, and a rear member 20 fixed to the frame 14 so as to cover the other opened surface of the hole portion 12.

In the soundproof cell 22 of the soundproof member 10 according to the present embodiment, the cut portion 18 penetrates toward the other surface from one surface of the film.

In the soundproof cell 22, a rear space of the film 16 surrounded by an inner peripheral surface of the frame 14 and the rear member 20 is closed.

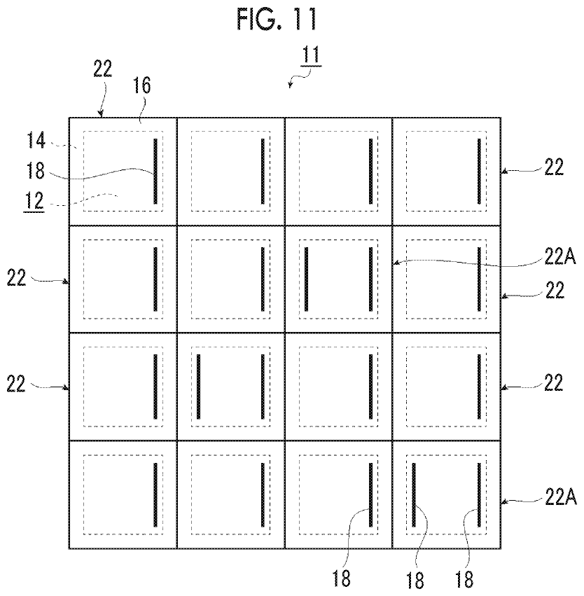

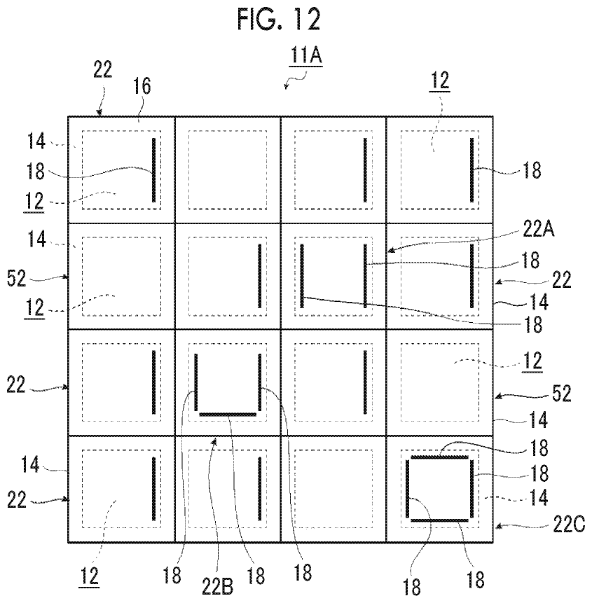

The soundproof member according to the embodiment of the present invention may include one or more soundproof cells, or may include a plurality (for example, 16) of soundproof cells as soundproof members 11 and 11A shown in FIGS. 11 and 12 to be described below.

The frame 14 of the soundproof cell 22 is constituted by a portion surrounding the hole portion 12.

The frame 14 is formed so as to surround the hole portion 12 penetrating therethrough in a cyclic shape, and is used for fixing and supporting the film 16 so as to cover one surface of the hole portion 12. The frame is a node of a film vibration of the film 16 fixed to the frame 14. Therefore, the frame 14 has higher stiffness than the film 16. Specifically, it is preferable that both the mass and the stiffness of the frame per unit area are high.

It is preferable that the shape of the frame 14 has a closed continuous shape capable of fixing an edge part of the film 16 so as to restrain the entire periphery of the film 16. The present invention is not limited thereto. The frame 14 may have a discontinuous shape by cutting a part thereof as long as the frame serves as the node of the film vibration of the film 16 fixed to the frame. That is, since the role of the frame 14 is to fix and support the film 16 to control the film vibration, the effect is achieved even in a case where there is a small cut in the frame 14 or there is an unbonded part.

The shape of the hole portion 12 of the frame 14 is a planar shape, and is a square in the example shown in FIGS. 1 and 4. In the present invention, the shape of the hole portion is not particularly limited, and may be a quadrangle such as a square, a rectangle, a diamond, or a parallelogram, a triangle such as an equilateral triangle, an isosceles triangle, or a right triangle, a polygon including a regular polygon such as a regular pentagon or a regular hexagon, an ellipse, a circle, and the like, or may be an irregular shape.

In the example shown in FIGS. 1 and 4, both end portions of the hole portion 12 of the frame 14 are not blocked, are opened ends, and are opened to the outside as they are. The film 16 is fixed to the frame 14 so as to cover the hole portion 12 at one opened end of the opened hole portion 12.

The rear member 20 is fixed to the frame 14 so as to cover the hole portion 12 at the other opened end of the opened hole portion 12.

In the present invention, both the end portions of the hole portion 12 of the frame 14 may be different from those in the example shown in FIGS. 1 to 4. That is, only the one end portion of the hole portion 12 may be opened to the outside, the rear member 20 may not be provided, and the other end portion may be blocked by the frame 14 itself. That is, three the frame 14 itself may be blocked in three directions, and may constitute the rear space of the film 16. In this case, the film 16 that covers the hole portion 12 is fixed to only the one end portion of the opened hole portion 12.

The size of the frame 14 is a size in plan view, that is, is L₁ of FIG. 2, and is defined as the size of the hole portion 12. Accordingly, hereinafter, it is assumed that the size of the frame 14 is a size L₁ of the hole portion 12. For example, in a case where the shape of the frame 14 in plan view is a circle or a regular polygon such as a square, the size of the frame 14 can be defined as a distance between opposite sides passing through the center of the regular polygon and face each other or a circle equivalent diameter. For example, in a case where the shape of the frame 14 in plan view is a polygon, an ellipse, or an irregular shape, the size of the frame 14 can be defined as a circle equivalent diameter. In the present invention, the circle equivalent diameter and the radius are a diameter and a radius at the time of conversion into circles having the same area.

The size L₁ of the hole portion 12 of the frame 14 is not particularly limited, and the sizes of the frames may be appropriately set according to a soundproofing target to which the opening member of the soundproof member 10 according to the embodiment of the present invention is applied in order to perform soundproofing. For example, the soundproofing target can be photocopiers, blowers, air conditioners, ventilation fans, pumps, generators, and ducts. In addition, the soundproofing target can be industrial machines such as various kinds of manufacturing machines such as a coating machine, a rotating machine, and a conveying machine. The soundproofing target can be transportation machines such as automobiles, trains, and aircrafts. The soundproofing target can be general household devices such as refrigerators, washing machines, dryers, televisions, copy machines, microwave ovens, game machines, air conditioners, fans, PCs, vacuum cleaners, and air purifiers.

It is preferable that the soundproof cell 22 including the frame 14 and the film 16 is smaller than a wavelength of a first natural vibration frequency of the film 16. Thus, that is, it is preferable that the size L₁ of the frame 14 is set to be small in order to set the size of the soundproof cell 22 to be smaller than the wavelength of the first natural vibration frequency.

For example, the size L₁ of the hole portion 12 is not particularly limited, and is preferably 0.5 mm to 300 mm, more preferably 1 mm to 100 mm, and most preferably 10 mm to 50 mm.

The thickness L₂ and width L₃ of the frame 14 are not particularly limited as long as the film 16 can be fixed and the film 16 can be reliably supported. For example, the thickness and width of the frame may be set depending on the size of the hole portion 12.

In addition, the thickness L₂ of the frame 14, that is, the hole portion 12 is preferably 0.5 mm to 200 mm, more preferably 0.7 mm to 100 mm, and most preferably 1 mm to 50 mm,

For example, in a case where the size L₁ of the hole portion 12 is 0.5 mm to 50 mm, the width L₃ of the frame 14 is preferably 0.5 mm to 20 mm, more preferably 0.7 mm to 10 mm, and most preferably 1 mm to 5 mm.

In a case where the size L₁ of the hole portion 12 exceeds 50 mm and is equal to or less than 300 mm, the width L₃ of the frame 14 is preferably 1 mm to 100 mm, more preferably 3 mm to 50 mm, and most preferably 5 mm to 20 mm.

In a case where a ratio (L₃; L₁) of the width L₃ of the frame 14 to the size L₁ of the frame 14 is too large, an area ratio of the portion of the frame 14 with respect to the entire structure increases. Accordingly, there is a concern that the device (soundproof cell 22) will become heavy. On the other hand, in a case where the ratio (L₃/L₁) is too small, it is difficult to strongly fix the film 16 with an adhesive or the like in the frame 14 portion.

It is preferable that the soundproof cell 22 is smaller than the wavelength of the first natural vibration frequency of the film 16. Accordingly, it is preferable that the size L₁ of the frame 14 (hole portion 12) is a size equal to or less than the wavelength of the first natural vibration frequency of the film 16 fixed to the soundproof cell 22.

As long as the size L₁ of the frame 14 (hole portion 12) of the soundproof cell 22 is the size equal to or less than the wavelength of the first natural vibration frequency of the film 16, a sound pressure having a small strength unevenness is applied to a film surface of the film 16. Thus, it is difficult to induce a vibration mode of the film for which sound control is difficult. That is, the soundproof cell 22 can obtain high sound controllability.

The case where a sound pressure having a smaller strength unevenness is applied to the film surface of the film 16 means that a sound pressure applied to the film surface of the film 16 is more uniform. As stated above, in order for the sound pressure applied to the film surface of the film 16 to be more uniform, in a case where the wavelength of the first natural vibration frequency of the film 16 fixed to the soundproof cell 22 is λ, the size L₁ of the frame 14 (hole portion 12) is preferably λ/2 or less, more preferably λ/4 or less, and most preferably λ/8 or less.

The material of the frame 14 is not particularly limited as long as the material can support the film 16, has a suitable strength in the case of being applied to the above soundproofing target, and is resistant to the soundproof environment of the soundproofing target, and can be selected according to the soundproofing target and the soundproof environment. Examples of the material of the frame 14 include metal materials such as aluminum, titanium, magnesium, tungsten, iron, steel, chromium, chromium molybdenum, nichrome molybdenum, and alloys thereof. Examples of the material of the frame 14 include resin materials such as acrylic resin, methyl polymethacrylate, polycarbonate, polyamide, polyamide, polyarylate, polyether imide, polyacetal, polyether ether ketone, polyphenylene sulfide, polysulfone, polyethylene terephthalate, polybutylene terephthalate, and triacetyl cellulose. The material of the frame can be carbon fiber reinforced plastic (CFRP), carbon fiber, and glass fiber reinforced plastic (GFRP).

A combination of a plurality of materials may be used as the material of the frame 14.

The rear member 20 closes the rear space of the film 16 surrounded by the inner peripheral surface of the frame 14.

The rear member 20 is a plate-shaped member, which faces the film 16 and is attached to the other end portion of the hole portion 12 of the frame 14, in order to make the space formed on the rear surface of the film 16 by the frame 14 be a closed space. Such a plate-shaped member is not particularly limited as long as a closed space can be formed on the rear surface of the film 16, but it is preferable to use a plate-shaped member formed of a material having higher stiffness than the film 16. For example, as a material of the rear member 20, it is possible to use the same material as the material of the frame 14 described above. The method of fixing the rear member 20 to the frame 14 is not particularly limited as long as a closed space can be formed on the rear surface of the film 16, and a method similar to the above-described method of fixing the film 16 to the frame 14 may be used.

Since the rear member 20 is a plate-shaped member for making the space formed on the rear surface of the film 16 by the frame 14 be a closed space, the rear member 20 may be integrated with the frame 14 or may be integrally formed with the same material.

Since the present embodiment is the soundproof cell through the film vibration in which there is a closed space volume on the rear surface of the film 16, it is preferable that the rear member 20 is provided.

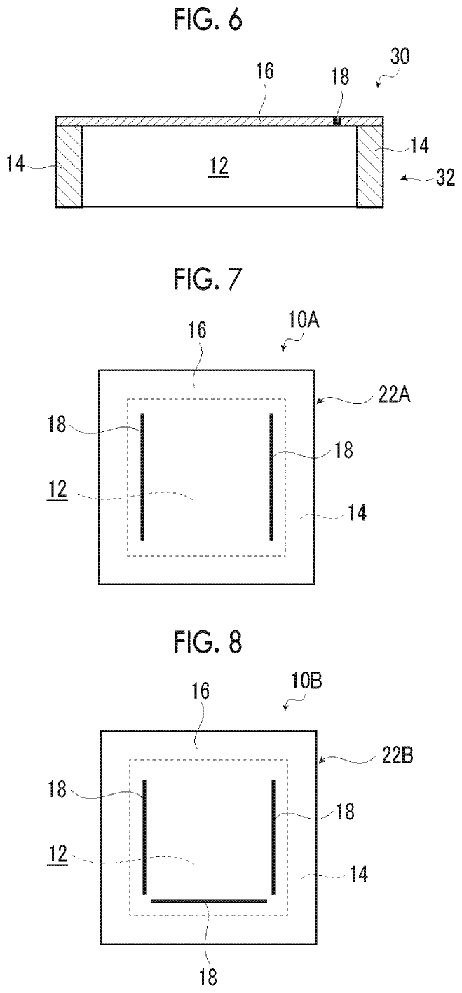

However, in the present invention, even though there is no closed space volume on the rear surface of the film 16, since the sound can be absorbed through the film vibration, the rear member 20 may be provided as shown in FIG. 6.

That is, a soundproof member 30 according to an embodiment shown in FIG. 6 is constituted by one soundproof cell 32 that includes a frame 14 having a hole portion 12 penetrating therethrough, a vibratable film 16 fixed to the frame 14 so as to cover one opened surface of the hole portion 12, and a cut portion 18 formed in the film 16.

In the soundproof cell 32 of the soundproof member 30 according to the present embodiment, a rear space of the film 16 surrounded by an inner peripheral surface of the frame 14 is opened.

The soundproof member 30 and the soundproof cell 32 shown in FIG. 6 have the same configurations as the soundproof member 10 and the soundproof cell 22 shown in FIGS. 1 to 4 except that the rear member 20 is not provided. A top view of the soundproof member 30 shown in FIG. 6 is the same as FIG. 4 which is a top view of the soundproof member 10 shown in FIGS. 1 to 3. Thus, in the soundproof member 30 shown in FIG. 6, the same components as those of the soundproof member 10 shown in FIGS. 1 to 4 will be assigned the same reference signs, and the description thereof will be omitted.

The film 16 is restrained by the frame 14 so as to cover the hole portion 12 within the frame 14, and the edge part thereof is fixed. The film 16 absorbs or reflects the energy of sound waves to insulate sound by performing film vibration corresponding to the sound waves from the outside.

Incidentally, since the film 16 needs to vibrate with the frame 14 as the node, the film needs to be fixed so as to be reliably restrained by the frame 14. The film 16 is an anti-node of the film vibration, and needs to insulate sound by absorbing or reflecting the energy of the sound waves. Therefore, it is preferable that the film 16 is made of a flexible elastic material.

Thus, the shape of the film 16 is the shape of the hole portion 12 of the frame 14 shown in FIGS. 1 and 4. As shown in FIG. 2, the size of the film 16 can be the size L₁ of the frame 14 (hole portion 12).

The thickness of the film 16 is not particularly limited as long as the film can vibrate by absorbing or reflecting the energy of sound waves to insulate sound. However, it is preferable that the thickness of the film 16 is thick in order to obtain a natural vibration mode on a high frequency side and is thin in order to obtain the natural vibration mode on a low frequency side. For example, in the present invention, the thickness L₄ of the film 16 shown in FIG. 2 can be set according to the size L₁ of the hole portion 12, that is, the size of the film 16.

For example, in a case where the size L₁ of the hole portion 12 is 0.5 mm to 50 mm, the thickness L₄ of the film 16 is preferably 0.001 mm (1 μm) to 5 mm, more preferably 0.005 mm (5 μm) to 2 mm, and most preferably 0.01 mm (10 μm) to 1 mm.

In a case where the size L₁ of the hole portion 12 exceeds 50 mm and are equal to or less than 300 mm, the thickness L₄ of the film 16 is preferably 0.01 mm (10 μm) to 20 mm, more preferably 0.02 mm (20 μm) to 10 mm, and most preferably 0.05 mm (50 μm) to 5 mm.

It is preferable that the thickness of the film 16 is expressed by an average thickness, for example, in a case where there are different thicknesses in one film 16.

Young's modulus of the film 16 is not particularly limited as long as the film 16 has elasticity capable of vibrating by absorbing or reflecting the energy of sound waves to insulate sound. It is preferable that the young's modulus of the film 16 is high in order to obtain the natural vibration mode on the high frequency side and is low in order to obtain the natural vibration mode on the low frequency side. In the present invention, the Young's modulus of the film 16 can be set according to the size L₁ of the frame 14 (hole portion 12) (that is, the size of the film).

For example, the Young's modulus of the film 16 is preferably 1000 Pa to 3000 GPa, more preferably 10000 Pa to 2000 GPa, and most preferably 1 MPa to 1000 GPa.

The density of the film 16 is not particularly limited as long as the film 16 can vibrate by absorbing or reflecting the energy of sound waves to insulate sound. For example, the density of the films 16 is preferably 5 kg/m³ to 30000 kg/m³, more preferably 10 kg/m³ to 20000 kg/m³, and most preferably 100 kg/m³ to 10000 kg/m³.

In a case where a film-shaped material or a foil-shaped material is used as the material of the film 16, the material needs to have a strength in the case of being applied to the above soundproofing target and needs to be resistant to the soundproof environment of the soundproofing target. The material of the film 16 needs to vibrate by absorbing or reflecting the energy of sound waves to insulate sound. The material of the film 16 is not particularly limited as long as the material has the aforementioned features, and can be selected according to the soundproofing target and the soundproof environment thereof.

For example, the material of the film 16 can be resin material that can be formed in a film shape such as polyethylene terephthalate (PET), polyimide, polymethylmethacrylate, polycarbonate, polymethyl methacrylate acrylic (PMMA), polyamideide, polyarylate, polyetherimide, polyacetal, polyetheretherketone, polyphenylene sulfide, polysulfone, polybutylene terephthalate, polyimide, triacetyl cellulose, polyvinylidene chloride, low density polyethylene, high density polyethylene, aromatic polyamide, silicone resin, ethylene ethyl acrylate, vinyl acetate copolymer, polyethylene, chlorinated polyethylene, polyvinyl chloride, polymethyl pentene, and polybutene. The material of the film 16 can he metal materials that can be made into a foil shape such as aluminum, chromium, titanium, stainless steel, nickel, tin, niobium, tantalum, molybdenum, zirconium, gold, silver, platinum, palladium, iron, copper, and permalloy can be mentioned. The material of the film can be materials or structures that can form a thin structure, such as materials that can be made into a fibrous film such as paper and cellulose, nonwoven fabrics, films containing nano-sized fibers, thinly processed porous materials such as urethane or Thinsulate, and carbon materials processed into a thin film structure.

In addition, the film 16 is fixed to the frame 14 so as to cover an opening on at least one side of the hole portion 12 of the frame 14. That is, the film 16 may be fixed to the frame 14 so as to cover openings on one side, the other side, or both sides of the hole portion 12 of the frame 14.

The method of fixing the film 16 to the frame 14 is not particularly limited, and any method of fixing the film 16 to the frame 14 such that the frame becomes the node of the film vibration may be used. For example, the method of fixing the film. 16 to the frame 14 can be a method using an adhesive or a method using a physical fixture.

In the method of using the adhesive, the adhesive is applied onto the surface surrounding the hole portion 12 of the frame 14 and the film 16 is placed thereon, so that the film 16 is fixed to the frame 14 with the adhesive. Examples of the adhesive include epoxy based adhesives (Araldite (registered trademark) (manufactured by Nichiban Co., Ltd.) and the like), cyanoacrylate based adhesives (Aron Alpha (registered trademark) (manufactured by Toagosei Co., Ltd.) and the like), and acrylic based adhesives.

As a method using a physical fixture, a method can be mentioned in which the film 16 disposed so as to cover the hole portion 12 of the frame 14 is interposed between the frame 14 and a fixing member, such as a rod, and the fixing member is fixed to the frame 14 by using a fixture, such as a screw or a small screw.

Although the frame 14 and the film 16 are separate members and the film 16 is fixed to the frame 14 in the soundproof cell 22 according to the present embodiment 1, the present invention is not limited thereto. The film 16 and the frame 14 which are made of the same material may be integrally formed.

In this example, the film 16 fixed to the frame 14 of the soundproof cell 22 has a first natural vibration frequency which is a frequency of a lowest-order natural vibration mode that can be induced in the structure of the soundproof cell 22. For example, the first natural vibration frequency which is the frequency of the lowest-order natural vibration mode is a resonance frequency in which a transmission loss of the film for a sound field substantially perpendicularly incident on the film 16 fixed to the frame 14 of the soundproof cell 22 is minimized and has a lowest-order absorption peak. That is, in the present invention, in the first natural vibration frequency of the film 16, the sound is transmitted and an absorption peak of the lowest-order frequency appears. In the present invention, the resonance frequency is determined by the soundproof cell 22 including the frame 14 and the film 16.

That is, in the resonance frequency in the structure including the frame 14 and the film 16, that is, the resonance frequency of the film 16 fixed so as to be restrained by the frame 14, the film vibration of the sound waves shakes the most. The sound waves are greatly transmitted in the resonance frequency, and the resonance frequency is a frequency of a natural vibration mode having an absorption peak of the lowest-order frequency.

In the present invention, the first natural vibration frequency is determined by the soundproof cell 22 including the frame 14 and the film 16. In the present invention, the first natural vibration frequency determined in this manner is referred to as the first natural vibration frequency of the film.

The first natural vibration frequency of the film 16 fixed to the frame 14 (for example, the first resonance frequency in which a boundary between a frequency region following the stiffness law and a frequency region following the mass law is the lowest order) is preferably 10 Hz to 100000 Hz which is equivalent to a range of sound waves that can be sensed by humans, more preferably 20 Hz to 20000 Hz which is an audible range of sound waves that can be heard by humans, even more preferably 40 Hz to 16000 Hz, and most preferably 100 Hz to 12000 Hz.

In this example, in the soundproof cell 22 according to the present embodiment, the resonance frequency (for example, the first natural vibration frequency) of the film 16 in the structure including the frame 14 and the film 16 can be determined by a geometric form of the frame 14 of the soundproof cell 22, stiffness of the film 16 of the soundproof cell 22, and a volume of a space behind the film. For example, the geometric form of the frame 14 can be the shape and dimension (size) of the frame 14. For example, the stiffness of the film 16 can be the thickness and flexibility of the film 16.

In the case of the same kind of films 16, a ratio between the thickness (t) of the film 16 and the square of the size (R) of the hole portion 12 (for example, a ratio [R²/t] of the thickness (t) to the size of one side in the case of the square) can be used as the parameter characterizing the first natural vibration mode of the film 16. In a case where the ratio [R²/t] is equal, the natural vibration mode has the same frequency (that is, the same resonance frequency). That is, the ratio [R²/t] has a constant value, and thus, the scale law is established. Accordingly, it is possible to select an appropriate size.

Incidentally, in the present invention, the film has one or more cut portions penetrating from one surface toward the other surface.

In the embodiment shown in FIGS. 1 and 4, the film 16 includes on cut portion 18 penetrating from one surface to the other surface. The cut portion 18 is linearly formed in parallel in line along one inner periphery (a fixed portion of the film 16 to one side of the frame 14) of the square frame 14 so as to penetrate the film 16. The cut portion 18 is formed in the end portion (a portion close to the inner periphery of the frame 14) of the film 16. For example, in a case where a length of the side of the frame 14 is 40 mm, the cut portion 18 is formed in a position separated from the inner periphery of the frame 14 by 2 mm.

Both end portions 18a and 18b of the linear cut portion 18 are formed on the film 16, but are formed on a side inner than two inner peripheries perpendicular to one inner periphery of the square frame 14.

In the present invention, it is preferable that the cut portion 18 is formed by forming a single linear slit penetrating through the film 16. It is preferable that the cut portion 18 is a slit formed by cutting the film 16 so as to penetrate from one surface to the other surface by using a thin cutter of a blade such a cutter knife. The thin cutter can be a cutter such as a round knife, a slitter blade, and a flat blade in addition to the cutter knife. The cut portion 18 may be formed by another method such as a laser cutter instead of the cutter.

In the soundproof member 10 according to the present embodiment, the film 16 has the cut portion 18, and thus, the absorption peak of the sound spreads in the first natural vibration frequency of the film 16 in the structure of the soundproof cell 22 including the frame 14 and the film 16 having the cut portion 18. That is, it is possible to widen the band of the absorption peak of the sound in the first natural vibration frequency of the film 16 in the soundproof cell 22.

The details will be described below. In this example, a soundproof cell 52 of a soundproof member 50 of the related art shown in FIG. 22 includes the frame 14, the film 16, and the rear member 20 similarly to the soundproof cell 22 of the soundproof member 10 shown in FIG. 1 but is different from the soundproof cell 22 in that the cut portion 18 is not formed in the film 16.

FIG. 23 is a graph showing soundproofing characteristics (absorption characteristics) of the soundproof member 50 (see Comparative Example 1 to be described below) of the related art shown in FIG. 22, and shows that a sharp absorption peak appears in 540 Hz which is the first resonance frequency.

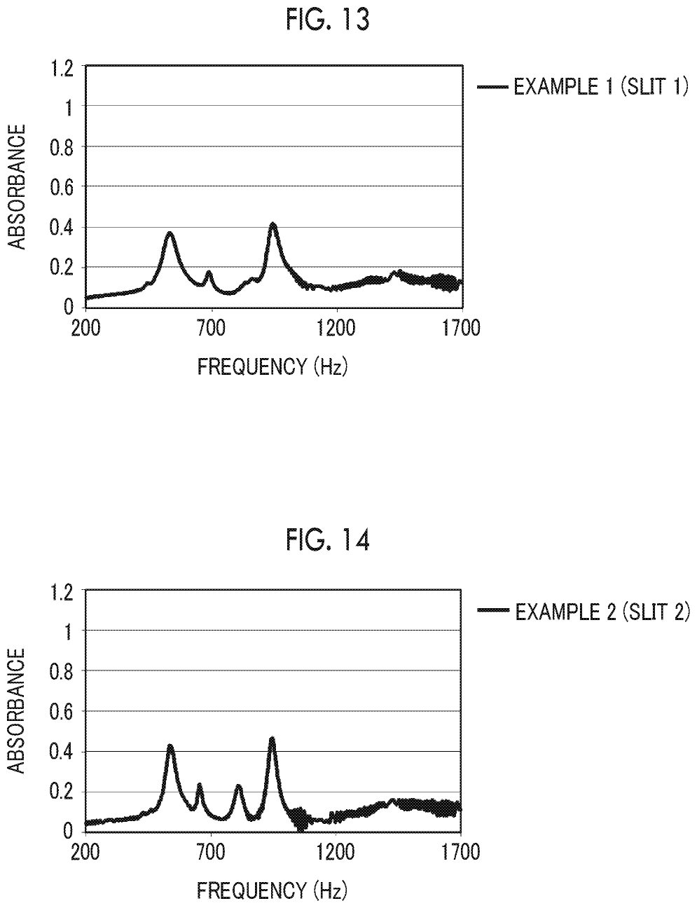

Meanwhile, FIG. 13 is a graph showing the soundproofing characteristics (absorption characteristics) of the soundproof member 10 (see Example 1 to be described below) according to the embodiment of the present invention shown in FIG. 1. It can be seen from FIG. 13 and FIG. 23 that the soundproof member 10 according to the embodiment of the present invention has substantially the same first resonance frequency as that of the soundproof member 50 of the related art. In the soundproof member 10 according to the embodiment of the present invention, it can be seen that the soundproof member 50 of the related has the absorption peak which spreads in the substantially same first resonance frequency as the first resonance frequency having a sharp absorption peak.

FIG. 16 is an enlarged view of only a low-frequency region (450 Hz to 650 Hz) of the absorption characteristics shown in FIGS. 13 and 23. In FIG. 16, a solid line represents the absorption characteristics of the soundproof member 50 of the related art (see FIG. 23), and a dotted line represents the absorption characteristics of the soundproof member 10 according to the embodiment of the present invention (see FIG. 13). It can be seen from FIG. 16 that the absorption peak of the soundproof member 10 according to the embodiment of the present invention has substantially the same peak frequency and the absorption peak spreads as compared to the absorption peak of the soundproof member 50 of the related art.

As stated above, since there is an individual difference or aging in a machine as the soundproofing target, it is desirable that the absorption peak spreads even in a noise control device of a specific frequency. Particularly, it is desirable that the absorption peak spreads by changing the structure using simple processing for forming the cut portion as the slit in the film.

As stated above, in the present invention, it is possible to widen the band of an original absorption peak by merely forming the cut portion as the slit in the film.

In the present invention, it is preferable that the length of the linear cut portion 18 is 25% or more of the length L₁ (see the size of the frame 14 shown in FIG. 2) of the side (inner periphery) of the square frame 14. The reason is that the absorption peak does not spread in case where the length of the cut portion 18 is less than 25% of the length of the side of the frame 14. In the present invention, the length of the cut portion 18 is more preferably 50% or more of the length of the side of the frame 14, and most preferably 65% or more of the length of the side of the frame. For example, in a case where the length of the side of the frame 14 is 40 mm, the length of the cut portion 18 is preferably 10 mm or more, more preferably 20 mm or more, and most preferably 26 mm or more.

It is preferable that the film 16 is left without forming the cut portion (slit) 18 at the top portion (corner) of the square frame 14. That is, it is preferable that the film 16 is fixed to the frame 14 in a state in which there is no cut portion 18 at the corner of the square frame 14. The length left on one side without forming the cut portion 18 in the film 16 at the corner portion of the square frame 14 is preferably 7.5% or more of the length L₁ of the side of the square frame 14, and more preferably 15% or more on both sides. Accordingly, an upper limit of the length of the linear cut portion 18 is preferably 85% or less of the length of the side of the square frame 14. The reason is that in a case where the length left on the film 16 is less than 7.5% of the length L₁ of the side of the frame 14 on one side and the cut portion 18 is termed by forming the slit in the film 16 after the film is attached to the frame 14, the slit is completely cut up to the end portion due to confliction of a cutting method using the cutter and the frame 14 itself. Even though the portion left on the film is 7.5% or more, since performance required in the present invention is obtained, it is easy to manufacture the soundproof member. In a case where the cut portions 18 are formed by forming slits in multiple sides, the slit is cut up to the end, and thus, two cut portions 18 are connected. Thus, the end portions of two sides are free ends easy to shake, and thus, it is difficult to obtain the effects of the present invention.

For example, in a case where the length of the side of the frame 14 is 40 mm, it is preferable that the length of the film 16 left at the corner portion of the frame 14 is 3 mm or more. Accordingly, it is preferable that the length of the cut portion 18 (slit length) is 34 mm or less.

In the present invention, as shown in FIGS. 4 and 5A, it is preferable that a cut surface (cut opening) 16a of a frame-side cut piece 16c of the film 16 cut by the cut portion 18 and a cut surface (cut opening) 16b of a center-side cut piece 16d of the film 16 have an overlapped portion 18c at least in a part in addition to both end portions 18a and 18b of the cut portion 18 in a thickness (L₄) direction of the film 16. In this case, it is more preferable that at least a contact part is present in the overlapped portion 18c of the cut surfaces 16a and 16b of the film 16 in the cut portion 18. As stated above, in a case where there is the overlapped portion 18c of the cut surfaces 16a and 16b of the film 16 or the contact part, the absorption peak spreads, and thus, the band is widened. The reason is that the present inventors have observed that since a fixed end state of the end portion of the film 16 fixed to the frame 14 is maintained to some extent and the cut surfaces 16a and 16b of the film 16 are overlapped, friction between the films 16 (friction through an air between the films 16) is generated, and the band of the absorption peak is widened. It is preferable that the thickness of the film 16 is thick in order to form the overlapped portion 18c of the cut surfaces 16a and 16b of the film 16.

Meanwhile, in the present invention, as shown in FIGS. 4 and 5B, the cut surface 16a of the frame-side cut piece 16c of the film 16 cut by the cut portion 18 and the cut surface 16b of the center-side cut piece 16d may have a portion at which the cut surfaces are not overlapped at least in a part in addition to both the end portions 18a and 18b of the cut portion 18 in the thickness (L₄) direction of the film 16. For example, a state shown in FIG. 5B is obtained by pushing the center-side cut piece 16d of the film 16. In a case where the film 16 tends to be softly deformed, this state is maintained. As stated above, in a case where the cut surfaces 16a and 16b of the cut portion 18 of the film 16 are completely shifted, an opening part 18d is formed in the cut portion 18. Thus, a vibration mode is changed to a free vibration. As a result, the absorption peak spreads, the band thereof is widened, but is shifted to the high frequency side.

Several cut portions 18 may be formed in the film 16, and the number of cut portions is not limited.

For example, as in a soundproof cell 22A (see Example 2) of a soundproof member 10A shown in FIG. 7, two cut portions 18 may be respectively formed in two opposite end portions of the film 16 so as to face the film 16 along opposite sides of the frame 14. In FIG. 7, the two cut portions 18 may be formed in the film 16 so as to face each other, but may be formed so as to adjacent in a L shape along sides adjacent to the frame 14.

As in a soundproof cell 22B (see Example 3) of a soundproof member 10B shown in FIG. 8, three cut portions 18 may be respectively formed in three end portions of the film 16 along three sides of the frame 14.

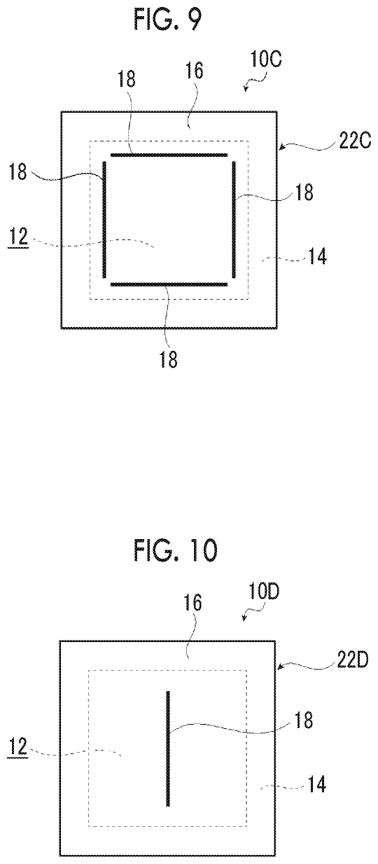

As in a soundproof cell 22C (see Example 9) of a soundproof member 10C shown in FIG. 9, four cut portions 18 may be respectively formed in four end portions of the film 16 along all four sides of the frame 14.

In this example, it is preferable that a small number of cut portions 18 is formed in the film 16. It is preferable that the number of cut portion 18 is most preferably one. The reason is that the absorption peak greatly spreads in a case where a small number of cut portions 18 is formed and the absorption peak spreads the most in a case where the number of cut portions 18 is one.

The cut portion 18 may be formed in any portion of the film 16.

For example, as in a soundproof cell 22D (see Example 10) of a soundproof member 10D shown in FIG. 10, the cut portion 18 may be formed in the center (the center of the hole portion 12 of the frame 14) of the film 16. In this case, there is an effect that the absorption peak spreads. However, it is preferable that the cut portion 18 is formed in the end portion (portion close to the fixed portion to the frame 14) of the film 16, as shown in FIGS. 1 to 9. The reason is that there is a large effect that the absorption peak spreads by forming the cut portion 18 in the end portion of the film 16.

Specifically, it is preferable that the cut portion 18 is within a range of 50% or less of a length of a perpendicular line from the inner periphery of the frame 14 in a case where the perpendicular line is dropped toward a center of gravity 16e of the film 16 vibrating from the inner periphery (the fixed portion of the film 16 to the frame 14) of the frame 14. The reason is that there is a small effect that the absorption peak spreads in a case where the cut portion is within a range of more than 50%. In this case, since the position of the cut portion 18 is located with the cut surface 16a of the frame-side cut piece 16c of the film 16 as a reference, a length from the inner periphery of the frame 14 to the cut surface 16a is within a range of 50% or less. The center of gravity 16e of the film 16 is the center of the film 16 in the example shown in FIG. 4, and the length of the perpendicular line is half (½) of the length L₁ of the side of the frame 14.

The cut portion 18 is more preferably within a range of 30% or less of the length of the perpendicular line from the inner periphery of the frame 14, and most preferably within a range of 1% or less. For example, in a case where the length L₁ of the side of the frame 14 is 40 mm, the cut portion 18 is preferably within a range of 10 mm or less from the inner periphery of the frame 14, more preferably within a range of 6 mm or less, and most preferably within a range of 3 mm or less.

As stated above, the cut surfaces 16a and 16b of the film 16 in the cut portion 18 have preferably the overlapped portion, and more preferably a contact portion. However, since the cut portion 18 is the slit formed by the cutter knife, a cut width corresponding to about the thickness of the cutter knife is present. The thickness of the cutter knife is about several hundred μm (for example, 380 μm). Thus, the cut width of the cut portion 18 is about several hundred μm (for example, 380 m).

As stated above, in the present invention, the cut width of the film 16 in the cut portion 18 is narrow, and the cut surfaces (cut surfaces 16a and 16b) of the film 16 are very close to each other. Thus, the cut surfaces (cut surfaces 16a and 16b) of the film 16 can be regarded as being maintained in the original state. That is, heights of the cut surfaces (cut surfaces 16a and 16b) of the film 16 can be regarded as being aligned. In other words, the cut surfaces (cut surfaces 16a and 16b) of the film 16 are overlapped in a case where the cut surfaces are viewed in a horizontal direction. In this case, the movement of the cut surfaces (cut surfaces 16a and 16b) of the film 16 is restricted, and the cut surfaces behave as substantially one film (four-side fixed end). Thus, it is considered that the resonance frequency is not almost changed. Meanwhile, since the fixed end state is slightly changed due to the slit, a Q value of a film type sound absorbing body becomes small, and it is considered that an effect that a resonance band spreads is obtained. In this example, the Q value of the film type sound absorbing body is an index representing resonance strength and sharpness. As the Q value becomes larger, the strength in the resonance frequency becomes large, but resonance becomes very sharp. In general, the resonance strength and the bandwidth have a trade-off relationship in the same system.

In a case where the cut width of the cut portion 18 becomes greater, a significant opening part 18d through which air freely passes is generated. In this case, the vibration mode is changed to the free vibration similarly to the case shown in FIG. 5B. As a result, the absorption peak spreads, the band thereof is widened, but is shifted to the high frequency side.

In a case where the cut width of the cut portion 18 becomes greater, an opening area determined by the cut width and length of the cut portion 18 effectively becomes large. For example, the opening area has a size effectively equal to a through-hole 64 as a resonance hole of a soundproof cell 62 of a soundproof member 60 shown in FIG. 25 disclosed in JP2009-139556A. Since the soundproof member 60 performs the sound absorption using the Helmholtz resonance, in the soundproof member 60, the absorption peak is drastically shifted to a high frequency, and the spread of a peak width is not able to be seen. In the present invention, hereinafter, the “resonance” is generally described without being distinguished.

In the present invention, since the spread of the peak width (wide band) in the absorption peak is required, it can he seen that the cut width with which the Helmholtz resonance does not occur is required as the cut width of the cut portion 18.

That is, it is preferable that the soundproof cell of the soundproof member according to the embodiment of the present invention exhibits resonance that includes the vibration of the film and is different from the Helmholtz resonance.

The soundproof members 10, 30, 10A, 10B, 10C, and 10D shown in FIGS. 1, 4, 6, 7, 8, 9, and 10 include the soundproof cells 22, 32, 22A, 22B, 22C, and 22D, respectively. However, the present invention is not limited thereto. A plurality of soundproof cells may be provided as in soundproof members 11 and 12 shown in FIGS. 11 and 12.

The soundproof member 11 shown in FIG. 11 includes 16 soundproof cells. 13 soundproof cells 22 shown in FIGS. 1 and 4 and three soundproof cells 22A shown in FIG. 7 are combined. The soundproof member includes a total of 16 soundproof cells, that is, two kinds of 16 soundproof cells according to the embodiment of the present invention.

The soundproof member 11A shown in FIG. 12 includes 16 soundproof cells. 9 soundproof cells 22 shown in FIGS. 1 and 4, one soundproof cell 22A shown in FIG. 7, one soundproof cell 22B shown in FIG. 8, one soundproof cell 22C shown in FIG. 9, and four soundproof cells 52 having no cut portion in the film 16 of the related art shown in FIG. 22 are combined. The soundproof member includes a total of 16 soundproof cells, that is, four kinds of soundproof cells according to the embodiment of the present invention and one kind of soundproof cell of the related art soundproof member.

In this case, 16 frames 14 of 16 soundproof cells of each of the soundproof members 11 and 11A may be constituted as one frame body. 16 films 16 of the 16 soundproof cells of each of the soundproof members 11 and 11A may be constituted by one sheet-shaped film body.

The soundproof member according to the embodiment of the present invention is not particularly limited as long as the soundproof member has at least one kind of a plurality of soundproof cells of the soundproof cells 22, 32, 22A, 22B, 22C, and 22D according to the embodiment of the present invention shown in FIGS. 1, 4, 6, 7, 8, 9, and 10. The soundproof member according to the embodiment of the present invention may include only one kind of soundproof cell according to the embodiment of the present invention, or may include the combination of two or more kinds of soundproof cells of the present invention. The soundproof member according to the embodiment of present invention may be the combination of one kind of soundproof cell according to the embodiment of the present invention and one or more kinds of soundproof cells of the related art, or may be the combination of two or more kinds of soundproof cells according to the embodiment of the present invention and one or more kinds of soundproof cells of the related art.

In the present invention, in a case where two or more kinds of soundproof cells according to the embodiment of the present invention are combined and one or more kinds of soundproof cells according to the embodiment of the present invention and one or more kinds of soundproof cells of the related art are combined, the number of individual kinds of soundproof cells is not also particularly limited.

The soundproof members 10, 30, 10A to 10D, 11, and 11A and the soundproof cells 22, 32, and 22A to 22D according to the embodiment of the present invention basically have the aforementioned configurations.

The soundproof member according to the embodiment of the present invention is manufactured as follows.

One or more frames having a hole portion, and one or more films respectively fixed to the one or more frames are prepared.

Subsequently, the peripheral portions of the one or more films are respectively fixed to the one or more frames by using an adhesive or a physical fixture.

Subsequently, the cut portions are formed by respectively forming the slits in the one or more films respectively fixed to the one or more frames by using the cutter knife.

In this manner, it is possible to manufacture the soundproof member according to the embodiment of the present invention including one or more soundproof cells.

Since the soundproof member and the soundproof cell according to the embodiment of the present invention basically have the aforementioned configurations, the following effects are obtained.

In the present invention, it is possible to change a behavior in the resonance frequency by forming the cut portion through the slit formed in the film of the soundproof cell. That is, in the present invention, the original absorption peak is changed by merely forming the cut portion as the slit in the film.

In the present invention, particularly, it is possible to widen the band of the absorption peak by widening the absorption band near the original resonance frequency (peak frequency) while maintaining the original resonance frequency in a state in the cut surfaces (cut openings) of both the cut pieces of the film are overlapped or are in contact with each other without pushing the one cut piece of the film while forming the cut portion as the slit in the film of the soundproof cell. That is, since the band is widened near the original absorption peak, the band is widened with the absorption of the original film vibration as a basis.

As stated above, it is possible to widen the absorption band while maintaining the peak frequency through the simple processing for forming the slit in the film in order to form the cut portion.

In the related art such as JP2009-139556A, a Helmholtz resonator is formed by forming the through-hole in a film vibration body.

In contrast, in the present invention, the cut portion is formed as the slit in the end portion of the film in order to change the vibration state of the film without aiming the Helmholtz resonance for causing a resonance phenomenon through the sound by using the through-hole.

As can be apparent that from the object of the technology of JP2009-139556A that “a resonance hole for the Helmholtz resonance formed in a film-shaped sound absorbing material is difficult to inhibit the film vibration of the film-shaped sound absorbing material”, the through-hole is formed in the end portion of the film in order not to change the original film vibration in the technology of JP2009-139556A. Meanwhile, in the present invention, the cut portion is formed by forming the slit in the end portion of the film, and thus, the wide band of the resonance frequency is realized by changing the vibration state of the film (changing the state of the fixed portion).

Accordingly, the through-hole of the technology of JP2009-139556A and the cut portion formed in the present invention are different.

In another patent of the film type sound absorbing body such as the technology of JP4832245B, it is not considered that the cut portion is formed in the film, and is not able to derive the present invention in which the band of the absorption peak is widened by changing the vibration state of the film.

As stated above, the present invention is an invention which is not capable of being easily derived from the related arts such as JP2009-139556A and JP4832245B.

Hereinafter, the physical properties or characteristics of a structural member that can be combined with a soundproof member having the soundproof member according to the embodiment of the present invention will be described.

[Flame Retardancy]

In the case of using a soundproof member having the soundproof member according to the embodiment of the present invention as a soundproof material in a building or a device, flame retardancy is required.

Therefore, the film is preferably flame retardancy. As the film, for example, Lumirror (registered trademark) nonhalogen flame-retardant type ZV series (manufactured by Toray Industries, Inc.) that is a flame-retardant PET film, Teijin Tetoron (registered trademark) UF (manufactured by Teijin Limited), and/or Dialamy (registered trademark) (manufactured by Mitsubishi Plastics, Inc.) that is a flame-retardant polyester film may be used.

The frame is also preferably a flame-retardant material. A metal such as aluminum, an inorganic material such as ceramic, a glass material, flame-retardant polycarbonate (for example, PCMUPY 610 (manufactured by Takiron Corporation)), and/or flame-retardant plastics such as flame-retardant acrylic (for example, Acrylite (registered trademark) FR1 (manufactured by Mitsubishi Rayon Co., Ltd.)) can be mentioned.

As a method of fixing the film to the frame, a bonding method using a flame-retardant adhesive (Three Bond 1537 series (manufactured by Three Bond Holdings Co., Ltd.)) or solder or a mechanical fixing method, such as interposing a film between two frames so as to be fixed therebetween, is preferable.

[Heat Resistance]

There is a concern that the soundproofing characteristics may be changed due to the expansion and contraction of the structural member of the soundproof member according to the embodiment of the present invention due to an environmental temperature change. Therefore, the material forming the structural member is preferably a heat resistant material, particularly a material having low heat shrinkage.

As the film, for example, Teijin Tetoron (registered trademark) film SLA (manufactured by Teijin Film Solutions Limited), PEN film Teonex (registered trademark) (manufactured by Teijin Film Solutions Limited), and/or Lumirror (registered trademark) off-anneal low shrinkage type (manufactured by Toray Industries, Inc.) are preferably used. In general, it is preferable to use a metal film, such as aluminum having a smaller thermal expansion factor than a plastic material.

As the frame, it is preferable to use heat resistant plastics, such as polyimide resin (TECASINT 4111 (manufactured by Enzinger Japan)) and/or glass fiber reinforced resin (TECAPEEK GF 30 (manufactured by Enzinger Japan)) and/or to use a metal such as aluminum, an inorganic material such as ceramic, or a glass material.

As the adhesive, it is preferable to use a heat resistant adhesive (TB 3732 (manufactured by Three Bond Holdings Co., Ltd.), super heat resistant one component shrinkable RTV silicone adhesive sealing material (manufactured by Momentive Performance Materials Japan) and/or heat resistant inorganic adhesive Aron Ceramic (registered trademark) (manufactured by Toagosei Co., Ltd.)). In the case of applying these adhesives to a film or a frame, it is preferable to set the thickness to 1 μm or less so that the amount of expansion and contraction can be reduced.

[Weather Resistance and Light Resistance]

In a case where the soundproof member having the soundproof member according to the embodiment of the present invention is arranged outdoors or in a place where light is incident, the weather resistance of the structural member becomes a problem.

Therefore, as the film, it is preferable to use a weather-resistant film, such as a special polyolefin film (ARTPLY (registered trademark) (manufactured by Mitsubishi Plastics, Inc.)), an acrylic resin film (ACRYPRENE (manufactured by Mitsubishi Rayon, Co., Ltd.)), and/or Scotch Calfilm (trademark) (manufactured by 3M).

As a frame material, it is preferable to use plastics having high weather resistance such as polyvinyl chloride, polymethyl methacryl (acryl), metal such as aluminum, inorganic materials such as ceramics, and/or glass materials.

As an adhesive, it is preferable to use epoxy resin based adhesives and/or highly weather-resistant adhesives such as Dry Flex (manufactured by Repair Care International).

Regarding moisture resistance as well, it is preferable to appropriately select a film, a frame, and an adhesive having high moisture resistance. Regarding water absorption and chemical resistance, it is preferable to appropriately select an appropriate film, frame, and adhesive.

[Dust]

During long-term use, dust may adhere to the film surface to affect the soundproofing characteristics of the soundproof member according to the embodiment of the present invention. Therefore, it is preferable to prevent the adhesion of dust or to remove adhering dust.

As a method of preventing dust, it is preferable to use a film formed of a material to which dust is hard to adhere. For example, by using a conductive film (Flecria (registered trademark) (manufactured by TDK Corporation) and/or NCF (Nagaoka Sangyou Co., Ltd.)) so that the film is not charged, it is possible to prevent adhesion of dust due to charging. It is also possible to suppress the adhesion of dust by using a fluororesin film (Dynoch Film (trademark) (manufactured by 3M)), and/or a hydrophilic film (Miraclain (manufactured by Lifegard Co.)), RIVEX (manufactured by Riken Technology Inc.) and/or SH2CLHF (manufactured by 3M). By using a photocatalytic film (Raceline (manufactured by Kimoto)), contamination of the film can also be prevented. A similar effect can also be obtained by applying a spray having the conductivity, hydrophilic property and/or photocatalytic property and/or a spray containing a fluorine compound to the film.

In addition to using the above special films, it is also possible to prevent contamination by providing a cover on the film. As the cover, it is possible to use a thin film material (Saran Wrap (registered trademark) or the like), a mesh having a mesh size not allowing dust to pass therethrough, a nonwoven fabric, a urethane, an airgel, a porous film, and the like.

As a method of removing adhering dust, it is possible to remove dust by emitting sound having the resonance frequency of a film and strongly vibrating the film. The same effect can be obtained even in a case where a blower or wiping is used,

[Wind Pressure]

The film is exposed to strong wind, and thus, the film is pressed. As a result, there is a possibility that the resonance frequency will be changed. Thus, nonwoven fabric, urethane, and/or a film is covered on the film, and thus, it is possible to suppress the influence of the wind.

In the soundproof member according to the present invention, since the influence (wind pressure and wind noise on the film) due to the occurrence of turbulent flow is suppressed by screening the wind by using the side surface of the soundproof member, it is preferable that a rectifying mechanism such as a rectifying plate that rectifies the wind is formed on the side surface of the soundproof member.

[Combination of Unit Cells]

Each of the soundproof members 10, 10A, 10B, 10C, and 10D according to the embodiment of the present invention shown in FIGS. 1, 4, 7, 8, 9, and 10 includes one frame 14, one film 16 attached to each frame, and each of the soundproof cells 22, 22A, 22B, 22C, and 22D having the cut portion 18 formed in the film 16, as a unit cell. Meanwhile, each of the soundproof members 11 and 11A according to the embodiment of the present invention includes a plurality of soundproof cells obtained by integrally forming one frame body in which a plurality of frames 14 is continuous, a sheet-shaped film body in which a plurality of films 16 attached to hole portions 12 of the plurality of frames 14 of one frame body is continuous, and cut portions 18 formed by slits in the plurality of films 16 in advance. As stated above, the soundproof member according to the embodiment of the present invention may be a soundproof member independently using the unit cells. The soundproof member according to the embodiment of the present invention may be a soundproof member obtained by integrally forming the plurality of soundproof cells in advance, or may be a soundproof member including the plurality of soundproof cells in which the plurality of unit cells is connected.

As a method of connecting the plurality of unit cells, the unit cells may be combined by attaching Velcro (registered trademark), a magnet, a button, a sucker, and/or recess and protrusion portions to the frame, or the plurality of unit cells can be connected by using a tape.

[Arrangement]

Since the soundproof member including the soundproof member according to the embodiment of the present invention can be easily attached to or detached from the wall, it is preferable that an attachment mechanism constituted by a magnetic body, Velcro (registered trademark), a button, or a suction cup is attached to the soundproof member.

[Frame Mechanical Strength]

As the size of the soundproof member including the soundproof member according to the embodiment of the present invention becomes large, the frame tends to vibrate, and a function as the fixed end for the film vibration is degraded. Thus, it is preferable that the frame stiffness increases by increasing the thickness of the frame. However, in a case where the thickness of the frame increases, the mass of the soundproof member increases, the advantage of the present soundproof member of which the weight is light is degraded.

Thus, since the increase in mass is reduced while maintaining high stiffness, it is preferable that a hole or a groove is formed in the frame.

It is possible to secure high stiffness and it is possible to reduce a weight by changing or combining an in-plane frame thickness. By doing this, it is possible to achieve both high stiffness and a light weight.

The soundproof member according to the embodiment of the present invention can be used as the following soundproof members.

For example, as soundproof members having the soundproof member according to the embodiment of the present invention, it is possible to mention: a soundproof member for building materials (soundproof member used as building materials); a soundproof member for air conditioning equipment (soundproof member installed in ventilation openings, air conditioning ducts, and the like to prevent external noise); a soundproof member for external opening part (soundproof member installed in the window of a room to prevent noise from indoor or outdoor); a soundproof member for ceiling (soundproof member installed on the ceiling of a room to control the sound in the room); a soundproof member for floor (soundproof member installed on the floor to control the sound in the room); a soundproof member for internal opening part (soundproof member installed in a portion of the inside door or sliding door to prevent noise from each room); a soundproof member for toilet (soundproof member installed in a toilet or a door (indoor and outdoor) portion to prevent noise from the toilet); a soundproof member for balcony (soundproof member installed on the balcony to prevent noise from the balcony or the adjacent balcony); an indoor sound adjusting member (soundproof member for controlling the sound of the room); a simple soundproof chamber member (soundproof member that can be easily assembled and can be easily moved); a soundproof chamber member for pet (soundproof member that surrounds a pet's room to prevent noise); amusement facilities (soundproof member installed in a game centers, a sports center, a concert hall, and a movie theater); a soundproof member for temporary enclosure for construction site (soundproof member for covering construction site to prevent leakage of a lot of noise around the construction site); and a soundproof member for tunnel (soundproof member installed in a tunnel to prevent noise leaking to the inside and outside the tunnel).

While the soundproof member according to the embodiment of the present invention has been described in detail with reference to various embodiments and examples, the present invention is not limited to these embodiments and examples, and various improvements or modifications may be made without departing from the scope and spirit of the present invention.

### EXAMPLES

The soundproof structure according to the embodiment of the present invention will be described in detail by way of examples.

Initially, as a preliminary step of manufacturing the soundproof member 10 (see FIG. 1) according to the embodiment of the present invention, the soundproof member 50 (see FIG. 22) including a single soundproof cell 52 having no cut portion 18 due to the slit in the film 16 was manufactured as Comparative Example 1.

### Comparative Example 1

A PET film (Lumirror S10 manufactured by Toray industries, Inc., and a thickness of 188 μm) was used as the film 16. A frame obtained by machining metal aluminum having a thickness of 20 mm and forming a square hole having an inner diameter of 40 mm as the hole portion 12 was used as the frame 14. A thickness of an outer peripheral frame portion was 3 mm. Similarly; a lid was prepared by preparing a metal aluminum plate having a thickness of 3 mm and having 46 mm square as the rear member 20 and attaching the rear member to one surface (the end portion of the hole portion 12) of the frame structure of the frame 14. The PET film was attached to the frame portion of the other surface of the frame structure. The PET film was attached to the frame portion by using a double-sided tape.

As shown in FIG. 22, the soundproof member 50 including the soundproof cell 52 of a sound absorption film structure having an inner thickness of 20 mm in which the one surface of the frame 14 is closed by the vibration film 16 of the PET film and the other surface is closed by the rear member 20 was manufactured.

Initially, the acoustic characteristics were measured in this state. In the sound measurement, the absorbance (1—transmittance—reflectance) was obtained by using the acoustic tube having an inner diameter of 8 cm and measuring the transmittance and the reflectance in a four-terminal method. As a result, it can he seen that sharp absorption appears in 540 Hz.

### Example 1

The cut portion 18 was formed in one side of the fixed end of the soundproof cell 52 of the sound absorption film structure of Comparative Example 1 by forming the slit by using the cutter knife. The soundproof member 10 according to Example 1 of the present invention shown in FIGS. 1 to 4 was manufactured in this manner. The cut portion 18 was formed by forming the slit in a position of 2 mm from the fixed portion such that the cut portion 18 is formed by forming the slit in a vibration portion of the film 16 as close to the fixed portion (inner periphery) of the frame 14 as possible. The acoustic characteristics were measured in this state.

### Example 2

Next, a second cut portion 18 formed by forming a second slit in the film 16 close to the fixed portion (opposite side) of the opposite sides of the cut portion 18 in the soundproof cell 22 of the sound absorption film structure having the cut portion 18 formed by forming the slit of Example 1 was formed. The soundproof member 10A according to Example 2 of the present invention shown in FIG. 7 was manufactured in this manner. Similarly to the cut portion 18, the second cut portion 18 (slit) was formed by forming the slit in the position of 2 mm from the fixed portion. The acoustic characteristics were measured in this state.

### Example 3

Next, a third cut portion 18 was formed by forming a third slit so as to connect two cut portions 18 in the soundproof cell 22A of the sound absorption film structure having the cut portion 18 in two portions of Example 2. The soundproof member 10B according to Example 3 of the present invention shown in FIG. 8 was manufactured in this manner. In this case, the cut portions 18 were formed by forming the slits in three sides of four sides close to the fixed end, and the structure of the film 16 has a cantilever shape. In Example 3, the film 16 is lightly pushed into the frame 14 by hand. The acoustic characteristics were measured in this state.

The measurement results of Examples 1, 2, and 3 and Comparative Example 1 are shown in FIGS. 13, 14, and 15 and FIG. 23, and an enlarged view of a low-frequency region near a first absorption peak is shown in FIG. 16. In FIG. 16, the measurement results of Example 3 are omitted.

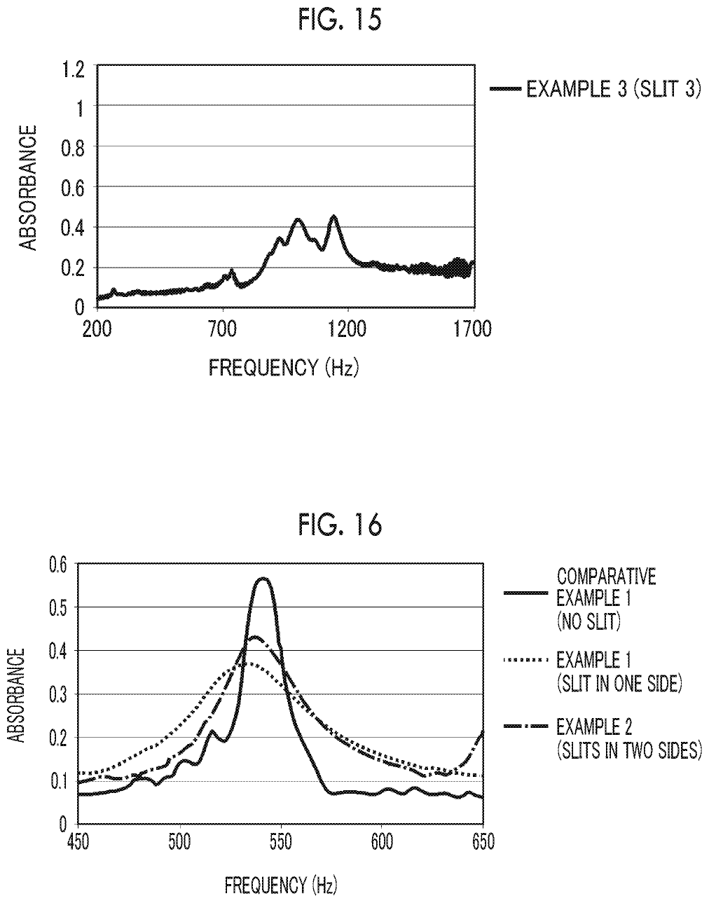

Initially, as shown in FIG. 15, in Example 3, the first absorption peak of the low frequency is reduced, and the first absorption peak is greatly shifted to the high frequency side. This is considered that since the end portion of the film 16 is close to the free end vibration from the original fixed end vibration or the vibration mode is changed to a three-side free vibration mode, the resonance of the vibration, that is, the first absorption peak is shifted to the high frequency side.

Meanwhile, as shown in FIGS. 23, 13, 14, and 16, it can be seen that Comparative Example 1 and Examples 1 and 2 in which the pushing is not performed have the first resonance frequency as the same frequency, and accordingly have the first absorption peak. In Examples 1 and 2, it can be seen that the heights of the first and second absorption peaks are close to each other as compared to Comparative Example 1.

It can be seen from FIG. 16 that the peak width of the absorption peak spreads by forming the cut portion 18 as the slit in Examples 1 and 2 as compared to Comparative Example 1 in which the original film 16 having no cut portion 18 is provided. In Examples 1 and 2, it can be seen that the absorption on the high frequency side also spreads.

By doing this, in the present invention, the band of the absorption peak could be widened by merely forming the cut portion 18 as the slit.

### Comparative Example 2

The soundproof member 50 (see FIG. 22) of Comparative Example 2 of the sound absorption film structure using the PET film (Lumirror S10 manufactured by Toray Industries, Inc.) of 125 μm instead of the PET film of 188 μm of Comparative Example 1 was manufactured. As a result of the sound measurement, it can be seen that the absorption peak appears in 640 Hz.

### Example 4

The cut portion 18 was formed by forming the slit in one side of the soundproof member of Comparative Example 2 by using the cutter knife. The cut portion 18 was formed at a distance of 2 mm from the fixed portion (the inner periphery of the frame 14) by forming the slit in the film 16. The soundproof member 10A (see FIG. 7) according to Example 4 of the present invention was manufactured in this manner.

The sound measurement was performed in a state in which the cut surfaces 16a and 16b of the cut portion 18 are overlapped.

### Example 5

The portion near the cut portion 18 of the center-side cut piece 16d of the vibration film 16 of Example 4 was pushed by a finger. Accordingly, the cut surfaces 16a and 16b of the cut portion 18 are shifted from each other. The soundproof member (see FIG. 5B) according to Example 5 of the present invention was manufactured in this manner. In a state in which the cut surfaces 16a and 16b of the cut portion 18 are shifted from each other and are not overlapped with each other, the acoustic characteristics were measured.

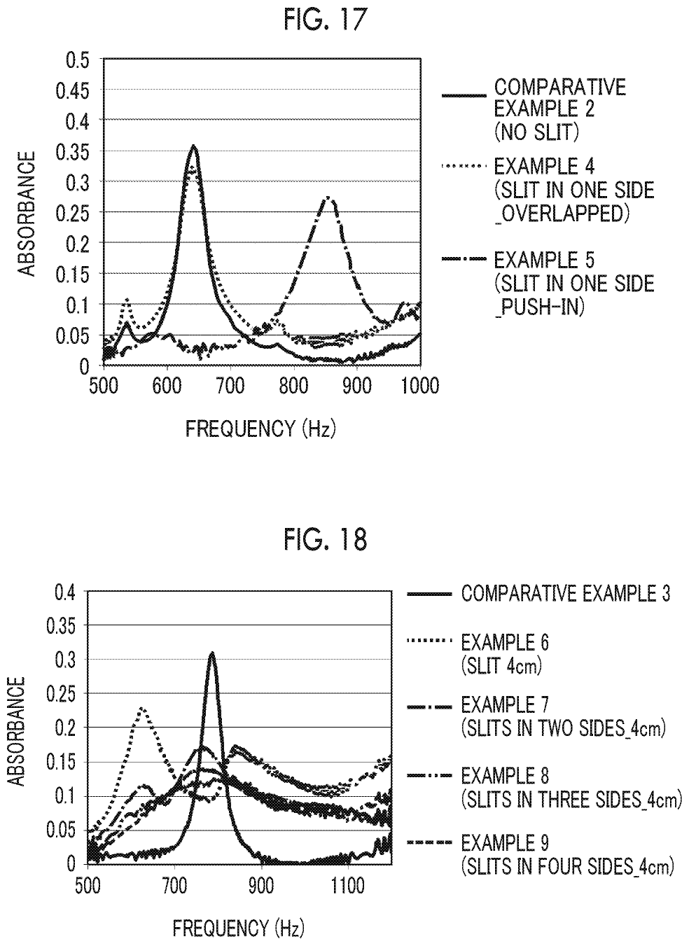

The measurement results of Comparative Example 2 and Examples 4 and 5 were shown in FIG. 17.

Initially, in a case where Comparative Example 2 and Example 4 are compared, in Example 4, the band of the first resonance frequency was widened by forming the cut portion 18 as the slit, as shown in FIG. 17. Meanwhile, the resonance frequency was greatly changed depending on whether or not the cut piece of the one side of the film 16 is pushed in a state in which the same film 16 as that of Examples 4 and 5 is used. In Example 5, since the end portion of the film 16 is changed to the free end from the fixed end, it is considered that the first resonance frequency is shifted to the high frequency.

Thus, it is possible to change the behavior in the resonance frequency by forming the cut portion 18 by forming the slit in the film 16. Particularly, the band could be widened while maintaining the original resonance frequency in a state in which the pushing is not performed while the cut portion 18 is formed. The features in this case are that the two cut pieces of the film 16 coming in contact with both sides of the cut surfaces of the cut portion 18 are maintained in the original state, that is, the heights thereof are aligned. In other words, the features of the state of the cut portion 18 are that the overlapped portion is present in a case where the cut surfaces 16a and 16b of the film 16 are viewed in the horizontal direction. In this case, a slit having several hundred μm formed by the cutter knife is merely present in the cut surface of the film 16, and thus, the cut pieces of the film 16 are very close to each other. In this state, the movement of the film 16 is restricted, and substantially behaves as the fixed end. Thus, it is considered that the resonance frequency is not substantially changed. Since the cut portion is a narrow slit-shaped gap, a particle velocity of an air in this gap becomes high, and thus, friction occurs. It is considered that the band of the peak is widened due to the effect that the sound is changed to heat due to the friction.

### Comparative Example 3

From the viewpoints, since it is estimated that the overlapped portion of the cut surfaces of the film 16 is important, the portion of the vibration film portion having the large thickness is easy to be heavy, and thus, it is possible to estimate that the effect of the wide band is high. Thus, the sound absorption film structure having the same configuration as that of Comparative Example 1 was manufactured as the soundproof member of Comparative Example 3 by using the PET film (Lumirror S10 manufactured by Toray Industries, Inc.) having a thickness of 350 μm of the vibration film 16. It can be seen from the measurement results of the acoustic tube that sharp absorption appears in 786 Hz.

### Examples 6 to 9

The soundproof members 10, 10A, 10B, and 10C (see FIGS. 4, 7, 8, and 9) according to Examples 6, 7, 8, and 9 of the present invention were sequentially manufactured by sequentially forming the cut portions 18 of 34 mm by forming the slits in 1, 2, 3, and 4 portions in the vibration film portion of the soundproof member of Comparative Example 3. The measurement of the acoustic tube was performed whenever the soundproof members of the examples are manufactured. In this example, the cut portion 18 was formed in a position of 2 mm from the fixed portion of the film 16. A space of 3 mm is formed between from front and rear end portions 18a and 18b of the cut portion 18 to the fixed portion of the film 16, and the cut portion is not completely cut off even though the cut portion 18 through the slit is increased. That is, the film 16 is fixed to the frame 14 while being left without being cut at the top portion of the frame 14.

The measurement results of Comparative Example 3 and Examples 6 to 9 were shown in FIG. 18.

As shown in FIG. 18, in any example of Examples 6 to 9, the absorption band greatly spreads on both sides of the absorption peak as compared to the original absorption peak. Particularly in a case where one cut portion 18 is formed through the slit, large absorption in which the band is widened such as a case where the absorption peak is generated on the low frequency side was represented.

### Comparative Examples 4 to 6

As Comparative Examples 4 to 6, the soundproof member in a state in which the surface is damaged by the cutter knife without completely forming the slit and in a state in which the cut portion 18 is not formed through the slits in the film 16 was manufactured. The measurement of the manufactured soundproof members of Comparative Examples 4 to 6 was performed. Comparative Example 4 is a soundproof member which has the sound absorption film structure manufactured in the completely same condition as that of Comparative Example 3 (see FIG. 22) and has no damage. Comparative Example 5 is a soundproof member having a damage of 34 mm in one side of the film 16, and Comparative Example 6 is a soundproof member having damages of 34 mm in two sides. The damaged portion formed in the film 16 is clearly scattered in white, and it is possible to estimate that the damage of several tens of μm or more is given. The acoustic characteristics in this case were measured.

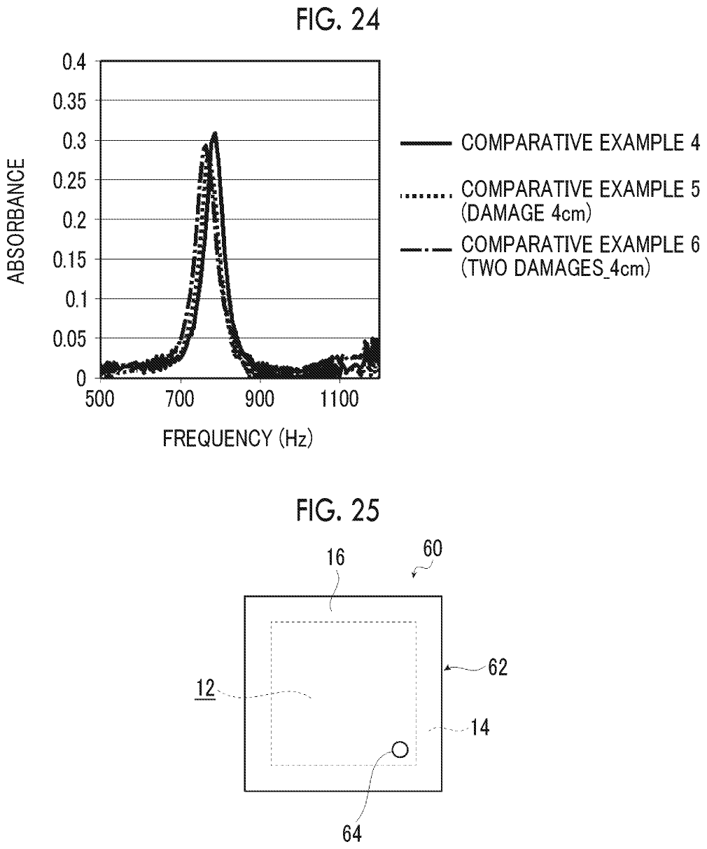

The measurement results of Comparative Examples 4 to 6 were shown in FIG. 24. As a result, the width of the absorption peak is not substantially changed before and after the damage is given, as shown in FIG. 24.

### Example 10

The slit is formed not at the end but in the middle of the vibration film portion of the soundproof member (see FIG. 22) of Comparative Example 3, and the soundproof member 10D according to Example 10 of the present invention including the soundproof cell 22D having the cut portion 18 in the middle of the film 16, as shown in FIG. 10. The acoustic characteristics in this case were measured.

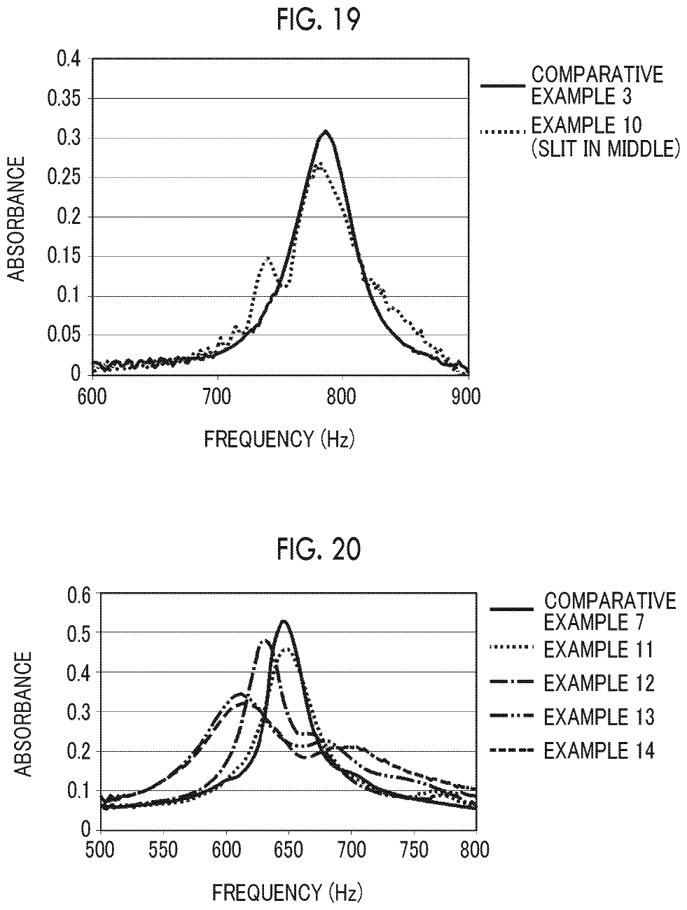

The measurement results of Example 10 and Comparative Example 3 were shown in FIG. 19.

As a result, the slight spread of the absorption peak is viewed as shown in FIG. 19, and the width of the spread of the absorption peak in a case where the cut portion 18 is formed by forming the slit in the end portion of the film 16 was wide, as in the soundproof members of Examples 6 to 9.

Although not shown, a soundproof member having a cross-shaped cut portion such that slits are formed in a cross shape in two sides in the middle of the film 16 of the soundproof member 10D of Example 10 shown in FIG. 10 was manufactured, and the acoustic characteristics were measured. The soundproof member having the cross-shaped cut portion exhibits the spread of the absorption peak, and is not much different from Example 10.

From the above, in a case where the cut surfaces 16a and 16b of the film 16 of the cut portion 18 of the film 16 are overlapped, it can be seen that the effect of the wide band of the absorption peak is larger in a case where the cut portion 18 is formed in the end portion of the film 16 than in a case where the cut portion is formed in the middle of the film 16.

### Comparative Example 7

The soundproof member 50 (see FIG. 22) of Comparative Example 7 of the sound absorption film structure using PET film (Lumirror S10 manufactured by Toray Industries, Inc.) of 250 μm instead of the PET film of 188 μm in Comparative Example 1 was manufactured. The sound measurement of the soundproof member of Comparative Example 7 was performed. As a result, it can be seen that the sharp absorption peak appears in 650 Hz.

### Examples 11 to 14

The cut portion 18 was formed by forming the slits 10 mm, 20 mm, 26 mm and 35 mm in one side of the soundproof member of Comparative Example 7 by using the cutter knife. The cut portion 18 was formed at a distance of 2 mm from the fixed portion (the inner periphery of the frame 14) by forming the slit in the film 16. The soundproof members (see FIGS. 1 to 4) according to Examples 11 to 14 of the present invention were manufactured in this manner. The acoustic characteristics of the manufactured soundproof members of Examples 11 to 14 were measured.

The measurement results are shown in FIG. 20.

As shown in FIG. 20, the length of the cut portion (slit) 18 of the film 16 is 10 mm or more, and the peak frequency of the absorption peak is slightly changed to low frequency, but the peak width of the absorption peak spreads. In the case of Example 11 in which the length of the cut portion 18 is 10 mm, the spread of the peak width of the absorption peak is small. Meanwhile, in the case of Example 12 in which the length of the cut portion 18 is 20 mm, the spread of the peak width is large. In the case of Examples 13 and 14 in which the length of the cut portion 18 is 26 mm or more, as the length of the cut portion 18 becomes long, the spread width of the absorption peak is further increased.

Thus, the length of the cut portion 18 of the film 16 is desirably 10 mm or more of 40 mm square which is the size of the film 16 (the hole portion 12 of the frame 14), more desirably 20 mm or more, and most desirably 26 mm or more.

Accordingly, a ratio of the length of the cut portion 18 of the film 16 to the length L₁ of the side of the film 16 (the hole portion 12 of the frame 14) is desirably 25% or more, more desirably 50% or more, and most desirably 65% or more.

In Example 14 in which the length of the cut portion 18 of the film 16 is 35 mm, since the thickness of the cutter knife used to cut the film 16 is 35 mm, it is considered that the cut width of the cut portion 18 has the width of the thickness of the cutter knife.

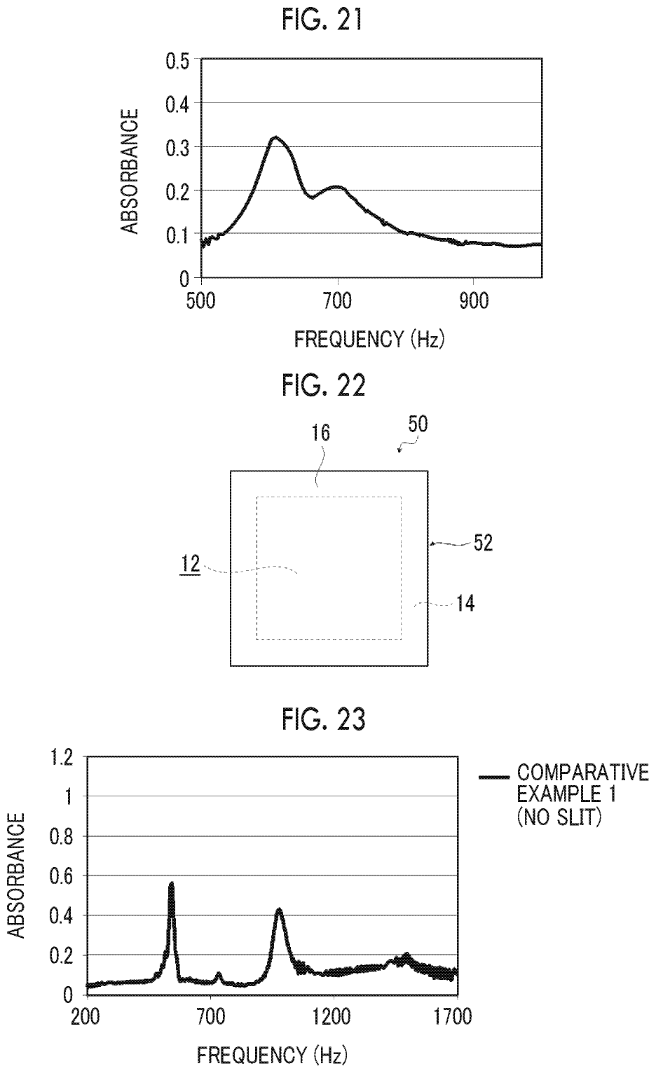

The acoustic characteristics of the soundproof member only of Example 14 are shown in FIG. 21. The peak frequency of Example 14 is 615 Hz (see FIG. 20).

In contrast, for example, in a case where the thickness of the film is 250 μm, the length of the cut portion 18 is 35 mm, and the Helmholtz resonance is performed, a theoretical value of the frequency of the Helmholtz resonance is 920 Hz, and is 1000 Hz or less. The absorption peak due to the Helmholtz resonance is present.

However, since the cut portion 18 having a cut length of 35 mm is present in the film 16, the resonance frequency (absorption peak frequency) of 615 Hz lower than 650 Hz which is the resonance frequency (absorption peak frequency) of the film vibration of the film 16 (see Comparative Example 7) having no cut portion 18 is shown in FIG. 21.

However, in FIG. 21, even though the cut portion 18 having the slit length of 35 mm is present in the film 16, the absorption due to the Helmholtz resonance does not appear.

From the above, it is considered that the cut portion is formed with the cut width with which the Helmholtz resonance does not occur in the measurement region in forming the cut portion through the slit by using the cutter knife according to the present example.

### Comparative Example 8

As shown in FIG. 25, the through-hole 64 having the hole diameter of 3 mm as the resonance hole was formed through punching in the soundproof member (see FIG. 22) of the structure in the same condition as that in Comparative Example 7. The soundproof member 60 of Comparative Example 8 shown in FIG. 25 was manufactured in this manner. As shown in FIG. 25, the through-hole 64 was formed in the position separated from the side by 2 mm. The acoustic characteristics of Comparative Example 8 were measured.

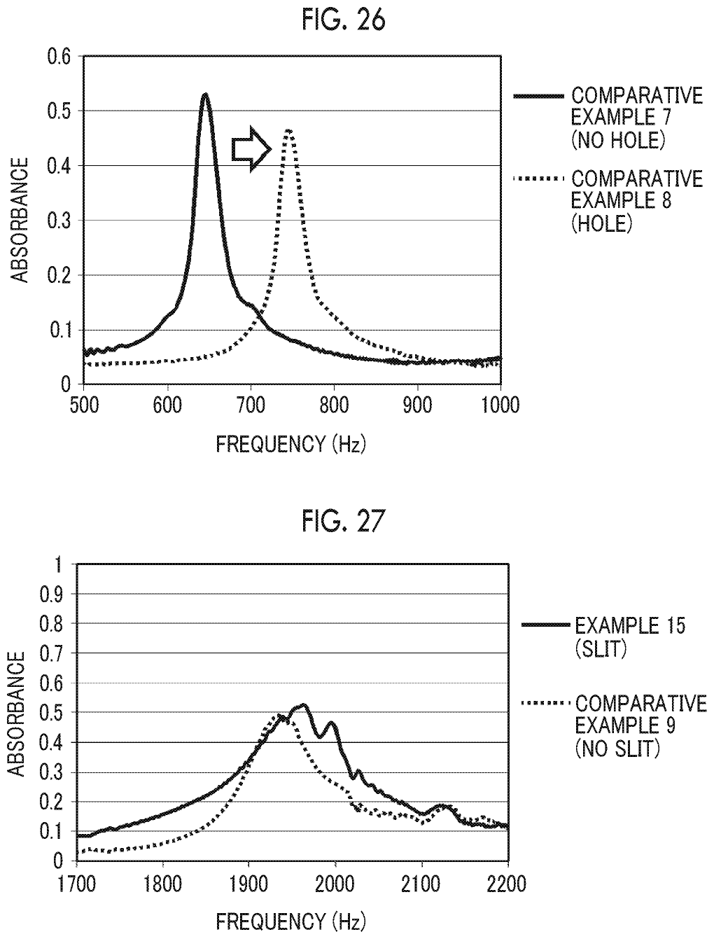

The results thereof are shown in FIG. 26.

The absorption peak appeared near 750 Hz by forming the through-hole 64.

In a case where the resonance frequency is calculated in the condition of the soundproof member 60 of Comparative Example 8, the theoretical value of the resonance frequency of the Helmholtz resonance is about 751 Hz. The frequency matches the peak of the Helmholtz resonance.

Meanwhile, as shown in FIG. 26, the absorption peak near 650 Hz derived from the film vibration in Comparative Example 7 disappeared by forming the through-hole 64.

That is, it can be seen that it is difficult to obtain the spread of the peak width of the absorption peak by forming the through-hole functioning as the Helmholtz resonance.

It is apparent from the results of FIGS. 24 and 26 that the cut portion through the slit formed in the film according to the embodiment of the present invention is not the resonance hole of the Helmholtz resonance.

That is, it is apparent that the soundproof cell of the soundproof member according to the embodiment of the present invention exhibits the absorption peak due to the film vibration in which the peak width spreads, exhibits the resonance of the film vibration, and the resonance is different from the Helmholtz resonance. Accordingly, the soundproof cell of the soundproof member according to the embodiment of the present invention exhibits the resonance that includes the vibration of the film, and is different from the Helmholtz resonance.

### Comparative Example 9

The sound absorption film structure of the related art which does not have the rear member and includes one side film 16 for the frame 14 having the hole portion 12 of openings on both surfaces and the soundproof cell in which one side is opened was manufactured similarly to Comparative Example 1 except that the rear member 20 is not present and the thickness is 350 μm.

### Example 15

Similarly to Example 1, the cut portion 18 was formed by forming the slit by using the cutter knife in the film 16 of the soundproof cell of the soundproof structure of Comparative Example 9, and the soundproof member 30 including the soundproof cell 32 shown in FIG. 6 was manufactured.

The acoustic characteristics of the manufactured soundproof members of Example 15 and Comparative Example 9 were measured.

The measurement results are shown in FIG. 27.

As shown in. FIG. 27, even in a case where the rear space of the film 16 is not closed, it can be seen that the band of the absorption peak is widened by forming the cut portion 18 by forming the slit.

The following effects were described in the aforementioned examples.

1. The behavior of the original resonance is changed by forming the cut portion 18 as the slit.

2. The cut surfaces of the cut pieces of the film are overlapped without being pushed, and thus, the band of the resonance width is widened.

3. The cut surfaces of the cut pieces of the film are present near the end portions in order to widen the band, and thus, the effect is further large.

From the above, the effect of the present invention is obvious.

The soundproof member according to the embodiment of the present invention can cause a peak to spread in addition to having an absorption peak of noise in a specific frequency in order to suppress noise having the specific frequency. Thus, in the soundproof member according to the embodiment of the present invention, the sound having the specific frequency such as the rotation sound of the motor and the vibration resonance sound of the machine is strongly transmitted. The soundproof member can be used in industrial machines such as copiers, transportation machines such as automobiles, general household equipment such as washing machines which do not avoid the individual difference or the aging.

### EXPLANATION OF REFERENCES

10, 10A, 10B, 10C, 10D, 11, 11A, 30, 50, 60: soundproof member

12: hole portion

14: frame

16: film

16a, 16b: cut surface (cut opening) of film

16c, 16d: cut piece of film

16e: center of gravity of film

18: cut portion

18a, 18b: end portion

18c: overlapped portion of cut surface of film

18d: opened portion of cut surface of film

20: rear member

22, 22A, 22B, 22C, 22D, 32, 52, 62: soundproof cell

64: through-hole

What is claimed is:

1. A single layer soundproof member comprising one or more soundproof cells,
wherein the soundproof cell includes a frame having a hole portion, a film fixed to the frame and that covers one opened end of the hole portion of the frame, and a rear member that closes a rear space of the film surrounded by an inner peripheral surface of the frame and covers the other opened end of the hole portion of the frame,
the film vibrates in response to sound,
the film includes one or more cut portions penetrating from one surface to the other surface, and
the cut portion is formed along an inner periphery of the frame.

2. The soundproof member according to claim 1,
wherein the soundproof cell exhibits resonance that includes vibration of the film, and is different from Helmholtz resonance.

3. The soundproof member according to claim 1,
wherein the cut portion is a slit formed by a cutter.

4. The soundproof member according to claim 1,
wherein in a case where a perpendicular line is dropped toward a center of gravity of the film vibrating from the inner periphery of the frame, the cut portion is within a range of 50% or less of a length of the perpendicular line from the inner periphery of the frame.

5. The soundproof member according to claim 1,
wherein a length of the cut portion is 25% or more of a length of an inner periphery of the frame.

6. The soundproof member according to claim 1,
wherein a frame-side cut surface of the film and a center-side cut surface of the film cut by the cut portion have an overlapped portion at least in a part in addition to both ends of the cut portion in a thickness direction of the film.

7. The soundproof member according to claim 6,
wherein the frame-side cut surface and the center-side cut surface of the film are in contact with each other at least in a part in addition to both the ends of the cut portion.

8. The soundproof member according to claim 1,
wherein the number of cut portions is one.

9. The soundproof member according to claim 1,
wherein the one or more soundproof cells are a plurality of the soundproof cells,
the soundproof member further includes a different kind of a plurality of other soundproof cells from the soundproof cells, and
the other soundproof cell fixes a film obtained by excluding the cut portion from the film to the frame.

10. A method of manufacturing a soundproof member at the time of manufacturing the soundproof member according to claim 1, the method comprising:
preparing one or more frames each having a hole portion and one or more films respectively fixed to the one or more frames;
fixing the one or more films to the one or more frames, respectively; and
forming one or more cut portions penetrating from one surface to the other surface of each film by forming a slit on the one or more films fixed to the one or more frames.
